(19) United States
(12) Patent Application Publication
(10) Pub. No.: US 2012/0013864 A1
(43) Pub. Date: Jan. 19, 2012

(54) LIQUID IMMERSION MEMBER, IMMERSION EXPOSURE APPARATUS, LIQUID RECOVERING METHOD, DEVICE FABRICATING METHOD, PROGRAM, AND STORAGE MEDIUM

(75) Inventor: Shinji SATO, Fukaya-shi (JP)

(73) Assignee: NIKON CORPORATION, Tokyo (JP)

(21) Appl. No.: 13/181,122

(22) Filed: Jul. 12, 2011

Related U.S. Application Data
(60) Provisional application No. 61/364,101, filed on Jul. 14, 2010.

(51) Int. Cl. G03B 27/52; G03B 27/42

(52) U.S. Cl. 355/30; 355/53

(57) ABSTRACT

A liquid immersion member is disposed inside an immersion exposure apparatus and at least partly around an optical member and around an optical path of exposure light that passes through a liquid between the optical member and an object. The liquid immersion member comprising: a first member, which has a recovery port that recovers at least some of the liquid from a space above the object; a recovery passageway, wherein the liquid recovered via the recovery port flows; a second member, which faces the recovery passageway and has a first discharge port that is for discharging the liquid from the recovery passageway; and a third member, which faces the recovery passageway and has a second discharge port that is for discharging a gas from the recovery passageway. The second member comprises a first portion and a second portion, which is disposed at a position higher than the first portion is and is capable of discharging a greater amount of the liquid than the first portion is.

### CROSS-REFERENCE TO RELATED APPLICATION

This application is a non-provisional application claiming priority to and the benefit of U.S. provisional application No. 61/364,101, filed Jul. 14, 2010. The entire contents of which are incorporated herein by reference.

### BACKGROUND

1. Field of the Invention

The present invention relates to a liquid immersion member, an immersion exposure apparatus, a liquid recovering method, a device fabricating method, a program, and a storage medium.

2. Description of Related Art

As disclosed in, for example, U.S. Patent Application Publication No. 2009/0046261, among exposure apparatuses used in photolithography, an immersion exposure apparatus is known that exposes a substrate with exposure light through a liquid in an immersion space.

### SUMMARY

In the immersion exposure apparatus, exposure failures might occur if, for example, the immersion space cannot be formed in a desired state. These problems could result in the production of defective devices.

An object of aspects of the present invention is to provide a liquid immersion member that can satisfactorily form an immersion space. Another object of aspects of the present invention is to provide both an immersion exposure apparatus and a liquid recovering method that can prevent exposure failures from occurring. Yet another object of aspects of the present invention is to provide a device fabricating method, a program, and a storage medium that can prevent defective devices from being produced.

A first aspect of the invention provides a liquid immersion member, which is disposed inside an immersion exposure apparatus and at least partly around an optical member and around an optical path of exposure light that passes through a liquid between the optical member and an object, that comprises: a first member, which has a recovery port that recovers at least some of the liquid from a space above the object; a recovery passageway, wherein the liquid recovered via the recovery port flows; a second member, which faces the recovery passageway and has a first discharge port that is for discharging the liquid from the recovery passageway; and a third member, which faces the recovery passageway and has a second discharge port that is for discharging a gas from the recovery passageway; wherein, the second member comprises a first portion and a second portion, which is disposed at a position higher than the first portion is and is capable of discharging a greater amount of the liquid than the first portion is.

A second aspect of the invention provides a liquid immersion member liquid immersion member, which is disposed inside an immersion exposure apparatus and at least partly around an optical member and around an optical path of exposure light that passes through a liquid between the optical member and an object, that comprises: a first member, which has a recovery port that recovers at least some of the liquid from a space above the object; a recovery passageway, wherein the liquid recovered via the recovery port flows; a second member, which has a first surface that faces the recovery passageway, a second surface that faces a direction other than that faced by the first surface, and a plurality of holes that connects the first surface and the second surface, that discharges at least some of the liquid from the recovery passageway via a first discharge port of the holes; and a third member, which faces the recovery passageway and has a second discharge port that is for discharging a gas from the recovery passageway; wherein, at least part of the first surface is nonparallel with respect to the horizontal plane.

A third aspect of the invention provides a liquid immersion member, which is disposed inside an immersion exposure apparatus and at least partly around an optical member and around an optical path of exposure light that passes through a liquid between the optical member and an object, that comprises: a first member, which has a recovery port that recovers at least some of the liquid from a space above the object; a recovery passageway, wherein the liquid recovered via the recovery port flows; a second member, which has a first surface that faces the recovery passageway, a second surface that faces a direction other than that faced by the first surface, and a plurality of holes that connects the first surface and the second surface, that discharges at least some of the liquid from the recovery passageway via a first discharge port of the holes; and a third member, which faces the recovery passageway and has a second discharge port that is for discharging a gas from the recovery passageway; wherein, at least part of the first surface is a curved surface.

A fourth aspect of the invention provides an immersion exposure apparatus, which exposes a substrate with exposure light that transits a liquid, that comprises: a liquid immersion member according to any one aspect of the first through third aspects.

A fifth aspect of the invention provides a device fabricating method that comprises: exposing a substrate using an immersion exposure apparatus according to the fourth aspect; and developing the exposed substrate.

A sixth aspect of the invention provides a liquid recovering method that is used by an immersion exposure apparatus wherein an immersion space is formed such that an optical path of exposure light between an optical member, wherefrom the exposure light can emerge, and a substrate is filled with a liquid and the substrate is exposed with the exposure light that transits the liquid, and that comprises: recovering at least some of the liquid from the space above the substrate via a recovery port of a first member; discharging at least some of the liquid from a recovery passageway via at least one portion of a second member, which has a first discharge port that is capable of discharging the liquid from the recovery passageway wherethrough the liquid recovered via the recovery port flows, selected from the group consisting of a first portion and a second portion, which is disposed at a position higher than the first portion is and is capable of discharging a greater amount of the liquid than the first portion is; and discharging at least some of a gas from the recovery passageway via a second discharge port of a third member that is capable of discharging the gas from the recovery passageway.

A seventh aspect of the invention provides a liquid recovering method that is used by an immersion exposure apparatus wherein an immersion space is formed such that an optical path of exposure light between an optical member, wherefrom the exposure light can emerge, and a substrate is filled with a liquid and the substrate is exposed with the exposure light that transits the liquid, and that comprises: recovering at least some of the liquid from the space above the substrate via a recovery port of a first member; discharging at least some of the liquid from a recovery passageway, wherethrough the liquid recovered via the recovery port flows, via a first discharge port of a plurality of holes of a second member, which has a first surface that is nonparallel with respect to the horizontal plane, a second surface that faces a direction other than that faced by the first surface, and the plurality of the holes that connects the first surface and the second surface; and discharging at least some of a gas from the recovery passageway via a second discharge port of a third member, which is disposed such that it faces the recovery passageway.

An eighth aspect of the invention provides a liquid recovering method that is used by an immersion exposure apparatus wherein an immersion space is formed such that an optical path of exposure light between an optical member, wherefrom the exposure light can emerge, and a substrate is filled with a liquid and the substrate is exposed with the exposure light that transits the liquid, and that comprises: recovering at least some of the liquid from the space above the substrate via a recovery port of a first member; discharging at least some of the liquid from a recovery passageway, wherethrough the liquid recovered via the recovery port flows, via a first discharge port of a plurality of holes of a second member, which has a first surface, at least part of which is a curved surface, a second surface that faces a direction other than that faced by the first surface, and the plurality of the holes that connects the first surface and the second surface; and discharging at least some of a gas from the recovery passageway via a second discharge port of a third member, which is disposed such that it faces the recovery passageway.

A ninth aspect of the invention provides a device fabricating method that comprises: filling an optical path of exposure light radiated to a substrate with a liquid using a liquid recovering method according to any one aspect of the sixth through eighth aspects; exposing the substrate with the exposure light that transits the liquid; and developing the exposed substrate.

A tenth aspect of the invention provides a program that causes a computer to control an exposure apparatus that exposes a substrate with exposure light that transits a liquid, and that comprises: forming an immersion space such that an optical path of the exposure light radiated to the substrate is filled with the liquid; exposing the substrate with the exposure light that transits the liquid in the immersion space; recovering at least some of the liquid from a space above the substrate via a recovery port of a first member; discharging at least some of the liquid from a recovery passageway via at least one portion of a second member, which has a first discharge port that is capable of discharging the liquid from the recovery passageway wherethrough the liquid recovered via the recovery port flows, from the group consisting of a first portion and a second portion, which is disposed at a position higher than the first portion is and is capable of discharging a greater amount of the liquid than the first portion is; and discharging at least some of a gas from the recovery passageway via a second discharge port of a third member, which is capable of discharging the gas from the recovery passageway.

An eleventh aspect of the invention provides a program that causes a computer to control an exposure apparatus that exposes a substrate with exposure light that transits a liquid, and that comprises: forming an immersion space such that an optical path of the exposure light radiated to the substrate is filled with the liquid; exposing the substrate with the exposure light that transits the liquid in the immersion space; recovering at least some of the liquid from a space above the substrate via a recovery port of a first member; discharging at least some of the liquid from a recovery passageway, wherethrough the liquid recovered via the recovery port flows, via a first discharge port of a plurality of holes of a second member, which has a first surface that is nonparallel with respect to the horizontal plane, a second surface that faces a direction other than that faced by the first surface, and the plurality of the holes that connects the first surface and the second surface; and discharging at least some of a gas from the recovery passageway via a second discharge port of a third member, which is disposed such that it faces the recovery passageway.

A twelfth aspect of the invention provides a program that causes a computer to control an exposure apparatus that exposes a substrate with exposure light that transits a liquid, and that comprises: forming an immersion space such that an optical path of the exposure light radiated to the substrate is filled with the liquid; exposing the substrate with the exposure light that transits the liquid in the immersion space; recovering at least some of the liquid from a space above the substrate via a recovery port of a first member; discharging at least some of the liquid from a recovery passageway, wherethrough the liquid recovered via the recovery port flows, via a first discharge port of a plurality of holes of a second member, which has a first surface, at least part of which is a curved surface, a second surface that faces a direction other than that faced by the first surface, and the plurality of the holes that connects the first surface and the second surface; and discharging at least some of a gas from the recovery passageway via a second discharge port of a third member, which is disposed such that it faces the recovery passageway.

A thirteenth aspect of the invention provides a computer readable storage medium, whereon a program according to any one aspect of the tenth through twelfth aspects is stored.

According to the aspects of the present invention, an immersion space can be formed satisfactorily. In addition, according to the aspects of the present invention, it is possible to prevent exposure failures from occurring and thereby to prevent defective devices from being produced.

### BRIEF DESCRIPTION OF THE DRAWINGS

FIG. 1 is a schematic block diagram that shows one example of an exposure apparatus according to a first embodiment.

FIG. 2 is a side cross sectional view that shows one example of a liquid immersion member according to the first embodiment.

FIG. 3 shows the liquid immersion member according to the first embodiment, viewed from above.

FIG. 4 shows the liquid immersion member according to the first embodiment, viewed from below.

FIG. 5 is a partial side cross sectional view of the liquid immersion member according to the first embodiment.

FIG. 6 is a schematic drawing that shows one example of a state wherein a second portion according to the first embodiment recovers a fluid.

FIG. 7 is a schematic drawing that shows one example of a state wherein a first portion according to the first embodiment recovers the fluid.

FIG. 8A is schematic drawings that show one example of a state wherein the first and second portions according to the first embodiment recover the fluid.

FIG. 8B is schematic drawings that show one example of a state wherein the first and second portions according to the first embodiment recover the fluid.

FIG. 9A is views for explaining a second member according to the first embodiment.

FIG. 9B is views for explaining a second member according to the first embodiment.

FIG. 10A is views for explaining one example of the second member according to a second embodiment.

FIG. 10B is views for explaining one example of the second member according to a second embodiment.

FIG. 11A is views for explaining one example of the second member according to a third embodiment.

FIG. 11B is views for explaining one example of the second member according to a third embodiment.

FIG. 12 is a view for explaining one example of the second member according to a fourth embodiment.

FIG. 13 is a view for explaining one example of the second member according to a fifth embodiment.

FIG. 14 is a partial side cross sectional view of the liquid immersion member according to a sixth embodiment.

FIG. 15 is a partial side cross sectional view of the liquid immersion member according to a seventh embodiment.

FIG. 16 is a partial side cross sectional view of the liquid immersion member according to the seventh embodiment.

FIG. 17 is a partial side cross sectional view of the liquid immersion member according to the seventh embodiment.

FIG. 18 is a partial side cross sectional view of the liquid immersion member according to the seventh embodiment.

FIG. 19 is a flow chart for explaining one example of a microdevice fabricating process.

FIG. 20 is a schematic drawing that shows one example of a state wherein a second portion according to the first embodiment recovers a fluid.

### DESCRIPTION OF EMBODIMENTS

The embodiments of the present invention will now be explained, referencing the drawings; however, the present invention is not limited thereto. The explanation below defines an XYZ orthogonal coordinate system, and the positional relationships among parts are explained referencing this system. Prescribed directions within the horizontal plane are the X axial directions, directions orthogonal to the X axial directions in the horizontal plane are the Y axial directions, and directions orthogonal to the X axial directions and the Y axial directions (i.e., the vertical directions) are the Z axial directions.

In addition, the rotational directions (i.e., the tilting directions) around the X, Y, and Z axes are the θX, θY, and θZ directions, respectively.

### First Embodiment

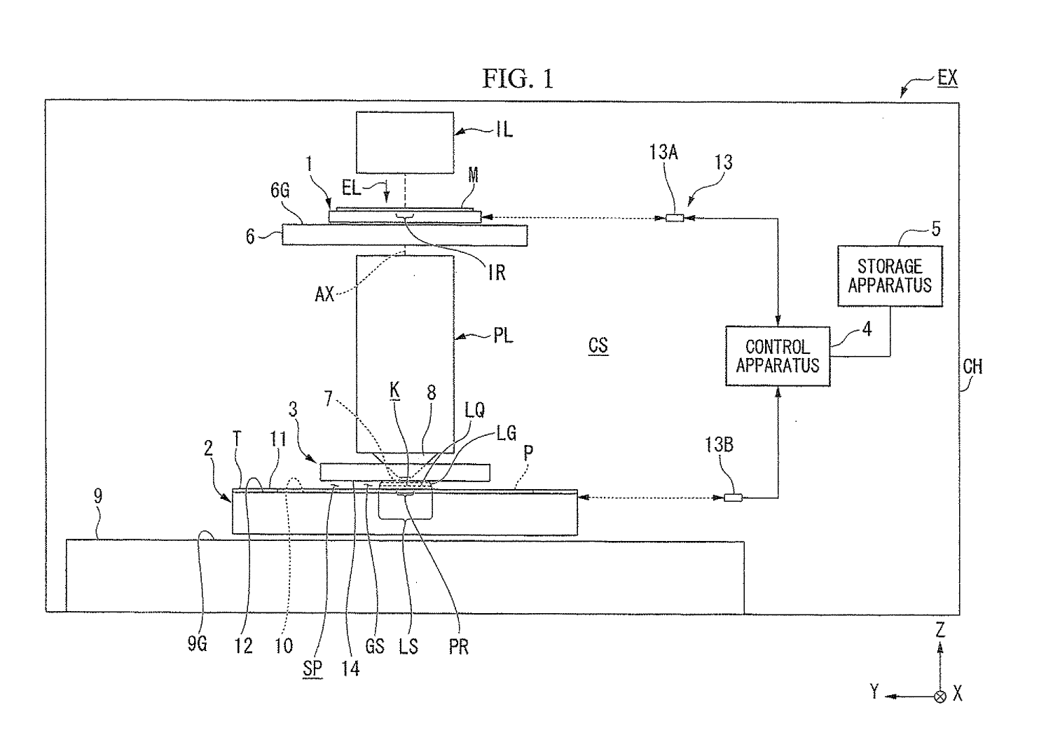

A first embodiment will now be explained. FIG. 1 is a schematic block diagram that shows one example of an exposure apparatus EX according to a first embodiment. The exposure apparatus EX of the present embodiment is an immersion exposure apparatus that exposes a substrate P with exposure light EL that passes through a liquid LQ. In the present embodiment, an immersion space LS is formed so that at least part of an optical path K of the exposure light EL is filled with the liquid LQ. An immersion space LS refers to a portion (i.e., a space or an area) that is filled with the liquid LQ. The substrate P is exposed with the exposure light EL, which transits the liquid LQ in the immersion space LS. In the present embodiment, water (i.e., pure water) is used as the liquid LQ.

In FIG. 1, the exposure apparatus EX comprises: a movable mask stage 1 that holds a mask M; a movable substrate stage 2 that holds the substrate P; an illumination system IL that illuminates the mask M with the exposure light EL; a projection optical system PL that projects an image of a pattern of the mask M, which is illuminated by the exposure light EL, to the substrate P; a liquid immersion member 3, which forms the immersion space LS by holding the liquid LQ between itself and the substrate P such that the optical path K of the exposure light EL radiated to the substrate P is filled with the liquid LQ; a control apparatus 4, which controls the operation of the entire exposure apparatus EX; and a storage apparatus 5, which is connected to the control apparatus 4 and stores various exposure-related information. The storage apparatus 5 comprises a storage medium such as memory (e.g., RAM), a hard disk, a CD-ROM, and the like. In the storage apparatus 5, an operating system (OS) that controls a computer system is installed and a program for controlling the exposure apparatus EX is stored.

In addition, the exposure apparatus EX comprises a chamber apparatus CH, which forms an internal space CS wherein at least the projection optical system PL, the liquid immersion member 3, and the substrate stage 2 are disposed. The chamber apparatus CH comprises an environmental control apparatus, which controls the environment (i.e., the temperature, the humidity, the pressure, and the cleanliness level) of the internal space CS.

The mask M may be a reticle on which a device pattern to be projected to the substrate P is formed. The mask M may be a transmissive mask comprising a transparent plate, such as a glass plate, and the pattern, which is formed on the transparent plate using a shielding material, such as chrome. Furthermore, the mask M may alternatively be a reflective mask.

The substrate P is a substrate for fabricating devices. The substrate P comprises, for example, a base material, such as a semiconductor wafer, and a photosensitive film, which is formed on the base material. The photosensitive film comprises a photosensitive material (e.g., photoresist). In addition to the photosensitive film, the substrate P may comprise a separate film. For example, the substrate P may comprise an antireflection film or a protective film (i.e., a topcoat film) that protects the photosensitive film.

The illumination system IL radiates the exposure light EL to a prescribed illumination area IR. The illumination area IR includes a position whereto the exposure light EL that emerges from the illumination system IL can be radiated. The illumination system IL illuminates at least part of the mask M disposed in the illumination area IR with the exposure light EL, which has a uniform luminous flux intensity distribution. Examples of light that can be used as the exposure light EL that emerges from the illumination system IL include: deep ultraviolet (DUV) light, such as a bright line (i.e., g-line, h-line, or i-line) light emitted from, for example, a mercury lamp, and KrF excimer laser light (with a wavelength of 248 nm); and vacuum ultraviolet (VUV) light, such as ArF excimer laser light (with a wavelength of 193 nm) and F₂ laser light (with a wavelength of 157 nm). In the present embodiment, ArF excimer laser light, which is ultraviolet light (e.g., vacuum ultraviolet light), is used as the exposure light EL.

In the state wherein it holds the mask M, the mask stage 1 is capable of moving on a guide surface 6G of a base member 6 that includes the illumination area IR. The mask stage 1 moves by the operation of a drive system, which comprises a planar motor as disclosed in, for example, U.S. Pat. No. 6,452,292. The planar motor comprises a slider, which is disposed on the mask stage 1, and a stator, which is disposed on the base member 6. In the present embodiment, the mask stage 1 is capable of moving in six directions along the guide surface 6G, namely, the X axial, Y axial, Z axial, θX, θY, and θZ directions, by the operation of the drive system.

The projection optical system PL radiates the exposure light EL to a prescribed projection area PR. The projection area PR includes a position whereto the exposure light EL that emerges from the projection optical system PL can be radiated. The projection optical system PL projects with a prescribed projection magnification an image of the pattern of the mask M to at least part of the substrate P, which is disposed in the projection area PR. The projection optical system PL of the present embodiment is a reduction system that has a projection magnification of, for example, ¼, ⅕, or ⅛. Furthermore, the projection optical system PL may be a unity magnification system or an enlargement system. In the present embodiment, an optical axis AX of the projection optical system PL is parallel to the Z axis. In addition, the projection optical system PL may be a dioptric system that does not include catoptric elements, a catoptric system that does not include dioptric elements, or a catadioptric system that includes both catoptric and dioptric elements. In addition, the projection optical system PL may form either an inverted or an erect image.

The projection optical system PL has an emergent surface 7 wherefrom the exposure light EL emerges and travels toward an image plane of the projection optical system PL. The emergent surface 7 belongs to a last optical element 8, which is the optical element of the plurality of optical elements of the projection optical system PL that is closest to the image plane of the projection optical system PL. The projection area PR includes a position whereto the exposure light EL that emerges from the emergent surface 7 can be radiated. In the present embodiment, the emergent surface 7 faces the −Z direction and is parallel to the XY plane. Furthermore, the emergent surface 7, which faces the −Z direction, may be a convex or a concave surface. The optical axis of the last optical element 8 is parallel to the Z axis. In the present embodiment, the exposure light EL that emerges from the emergent surface 7 proceeds in the −Z direction.

In the state wherein it holds the substrate P, the substrate stage 2 is capable of moving on a guide surface 9G of a base member 9, which includes the projection area PR. The substrate stage 2 moves by the operation of a drive system, which comprises a planar motor as disclosed in, for example, U.S. Pat. No. 6,452,292. The planar motor comprises a slider, which is disposed on the substrate stage 2, and a stator, which is disposed on the base member 9. In the present embodiment, the substrate stage 2 is capable of moving in six directions along the guide surface 9G, namely, the X axial, Y axial, Z axial, θX, θY, and θZ directions, by the operation of the drive system. Furthermore, the drive system that moves the substrate stage 2 does not have to comprise a planar motor. For example, the drive system may comprise a linear motor.

The substrate stage 2 comprises a substrate holding part 10, which releasably holds the substrate P. The substrate holding part 10 holds the substrate P such that the front surface thereof faces the +Z direction. In the present embodiment, the front surface of the substrate P held by the substrate holding part 10 and an upper surface 11 of the substrate stage 2 disposed around the substrate P are disposed within the same plane (i.e., they are flush with one another). The upper surface 11 is flat. In the present embodiment, the front surface of the substrate P, which is held by the substrate holding part 10, and the upper surface 11 of the substrate stage 2 are substantially parallel to the XY plane.

Furthermore, the upper surface 11 of the substrate stage 2 and the front surface of the substrate P held by the substrate holding part 10 do not have to be disposed within the same plane; furthermore, the front surface of the substrate P or the upper surface 11, or both, may be nonparallel to the XY plane. In addition, the upper surface 11 does not have to be flat. For example, the upper surface 11 may include a curved surface.

In addition, in the present embodiment, the substrate stage 2 comprises a cover member holding part 12, which releasably holds a cover member T, as disclosed in, for example, U.S. Patent Application Publication No. 2007/0177125 and U.S. Patent Application Publication No. 2008/0049209. In the present embodiment, the upper surface 11 of the substrate stage 2 includes an upper surface of the cover member T held by the cover member holding part 12.

Furthermore, the cover member T does not have to be releasable. In such a case, the cover member holding part 12 could be omitted. In addition, the upper surface 11 of the substrate stage 2 may include the front surface of any sensor, measuring member, or the like installed on the substrate stage 2.

In the present embodiment, an interferometer system 13, which comprises laser interferometer units 13A, 13B, measures the positions of the mask stage 1 and the substrate stage 2. The laser interferometer unit 13A is capable of measuring the position of the mask stage 1 using measurement mirrors, which are disposed on the mask stage 1. The laser interferometer unit 13B is capable of measuring the position of the substrate stage 2 using measurement mirrors, which are disposed on the substrate stage 2. When an exposing process or a prescribed measuring process is performed on the substrate P, the control apparatus 4 controls the positions of the mask stage 1 (i.e., the mask M) and the substrate stage 2 (i.e., the substrate P) based on the measurement results of the interferometer system 13.

The exposure apparatus EX of the present embodiment is a scanning type exposure apparatus (i.e., a so-called scanning stepper) that projects the image of the pattern of the mask M to the substrate P while synchronously moving the mask M and the substrate P in prescribed scanning directions. In the present embodiment, the scanning directions (i.e., the synchronous movement directions) of both the substrate P and the mask M are the Y axial directions. The control apparatus 4 radiates the exposure light EL to the substrate P through the projection optical system PL and the liquid LQ in the immersion space LS above the substrate P while moving the substrate P in one of the Y axial directions with respect to the projection area PR of the projection optical system PL and moving the mask M, synchronized to the movement of the substrate P, in the other Y axial direction with respect to the illumination area IR of the illumination system IL.

The liquid immersion member 3 forms the immersion space LS such that the optical path K of the exposure light EL radiated to the projection area PR is filled with the liquid LQ. The liquid immersion member 3 forms the immersion space LS by holding the liquid LQ between itself and an object, which is disposed at a position to which the exposure light EL emerging from the emergent surface 7 of the last optical element 8 can be radiated, such that the optical path K of the exposure light EL between the last optical element 8 and the object is filled with the liquid LQ.

In the present embodiment, the position whereto the exposure light EL emerging from the emergent surface 7 can be radiated includes the projection area PR. In addition, the position whereto the exposure light EL that emerges from the emergent surface 7 can be radiated includes the position at which the object opposes the emergent surface 7. In the present embodiment, the object that is capable of being disposed at the position at which the object opposes the emergent surface 7, in other words, the object that is capable of being disposed in the projection area PR, may be either the substrate stage 2 or the substrate P, which is held by the substrate stage 2 (i.e., the substrate holding part 10), or both. In the exposure of the substrate P, the liquid immersion member 3 forms the immersion space LS by holding the liquid LQ between itself and the substrate P such that the optical path K of the exposure light EL radiated to the substrate P is filled with the liquid LQ.

In the present embodiment, the liquid immersion member 3 is disposed at least partly around the last optical element 8 and the optical path K of the exposure light EL wherethrough the liquid LQ between the last optical element 8 and the object disposed in the projection area PR passes. In the present embodiment, the liquid immersion member 3 is annular. In the present embodiment, part of the liquid immersion member 3 is disposed around the last optical element 8 and part of the liquid immersion member 3 is disposed around the optical path K of the exposure light EL between the last optical element 8 and the object. The immersion space LS is formed such that the optical path K of the exposure light EL between the last optical element 8 and the object disposed in the projection area PR is filled with the liquid LQ.

Furthermore, the liquid immersion member 3 does not have to be annular. For example, the liquid immersion member 3 may be disposed partly around the last optical element 8 and the optical path K. In addition, the liquid immersion member 3 does not have to be disposed at least partly around the last optical element 8. For example, the liquid immersion member 3 may be disposed at least partly around the optical path K between the emergent surface 7 and the object and not around the last optical element 8. In addition, the liquid immersion member 3 does not have to be disposed at least partly around the optical path K between the emergent surface 7 and the object. For example, the liquid immersion member 3 may be disposed at least partly around the last optical element 8 and not around the optical path K between the emergent surface 7 and the object.

The liquid immersion member 3 has a lower surface 14 that is capable of opposing the front surface (i.e., the upper surface) of the object disposed in the projection area PR. The lower surface 14 of the liquid immersion member 3 can hold the liquid LQ between itself and the front surface of the object. In the present embodiment, some of the liquid LQ in the immersion space LS is held between the last optical element 8 and the object disposed such that the object opposes the emergent surface 7 of the last optical element 8. In addition, some of the liquid LQ in the immersion space LS is held between the liquid immersion member 3 and the object disposed such that the object opposes the lower surface 14 of the liquid immersion member 3. Holding the liquid LQ between the emergent surface 7 and the lower surface 14 on one side and the front surface (i.e., the upper surface) of the object on the other side forms the immersion space LS such that the optical path K of the exposure light EL between the last optical element 8 and the object is filled with the liquid LQ.

In the present embodiment, when the substrate P is being irradiated with the exposure light EL, the immersion space LS is formed such that part of the area of the front surface of the substrate P that includes the projection area PR is covered with the liquid LQ. At least part of an interface LG (i.e., a meniscus or edge) of the liquid LQ is formed between the lower surface 14 of the liquid immersion member 3 and the front surface of the substrate P. Namely, the exposure apparatus EX of the present embodiment adopts a local liquid immersion system. The outer side of the immersion space LS (i.e., the outer side of the interface LG) is a gas space GS.

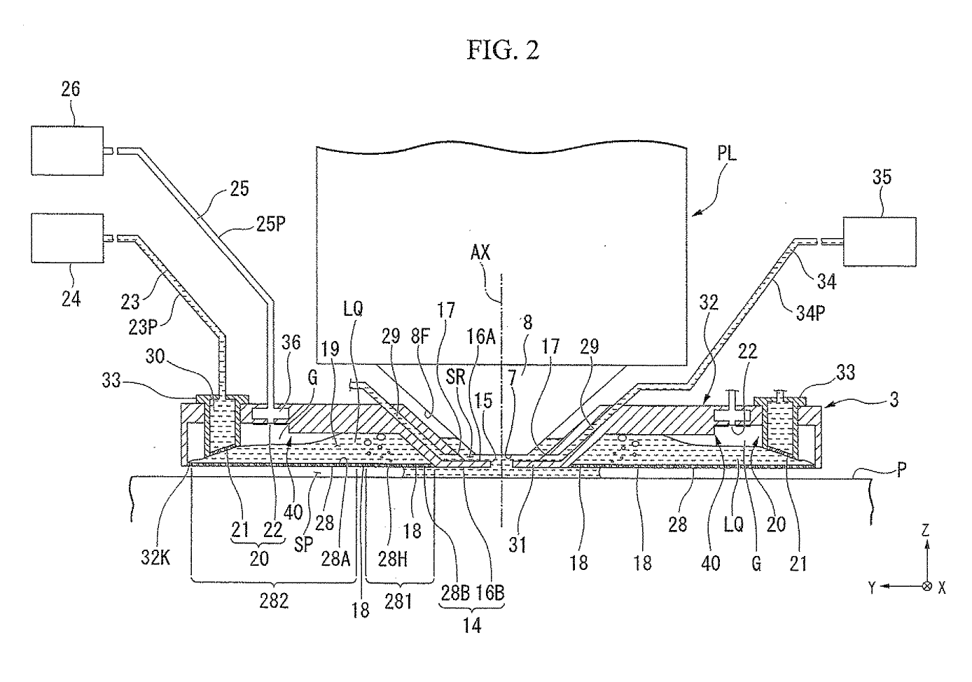

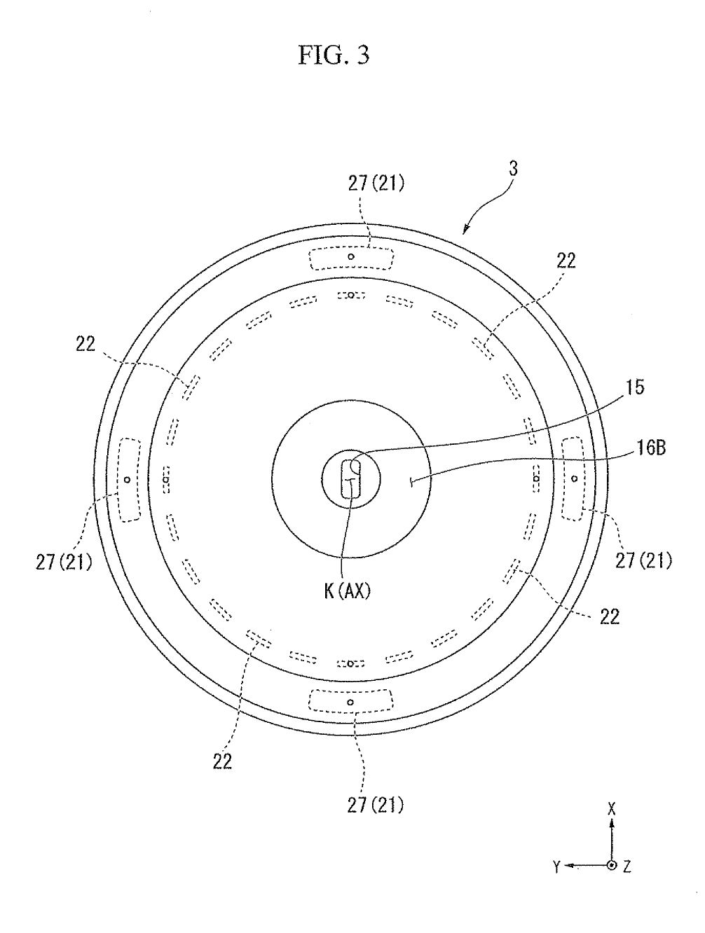

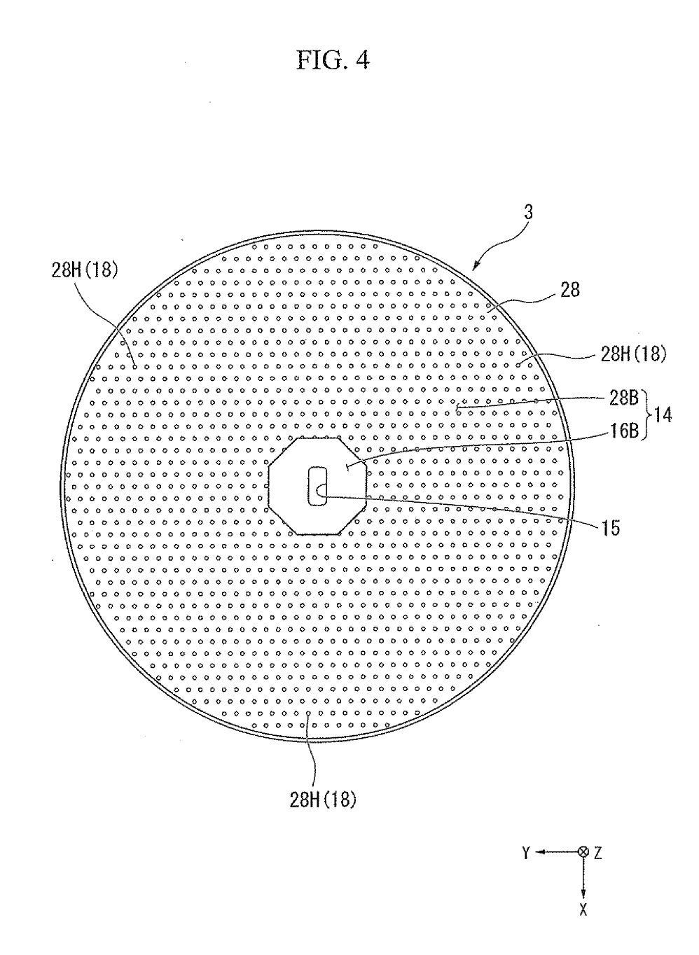

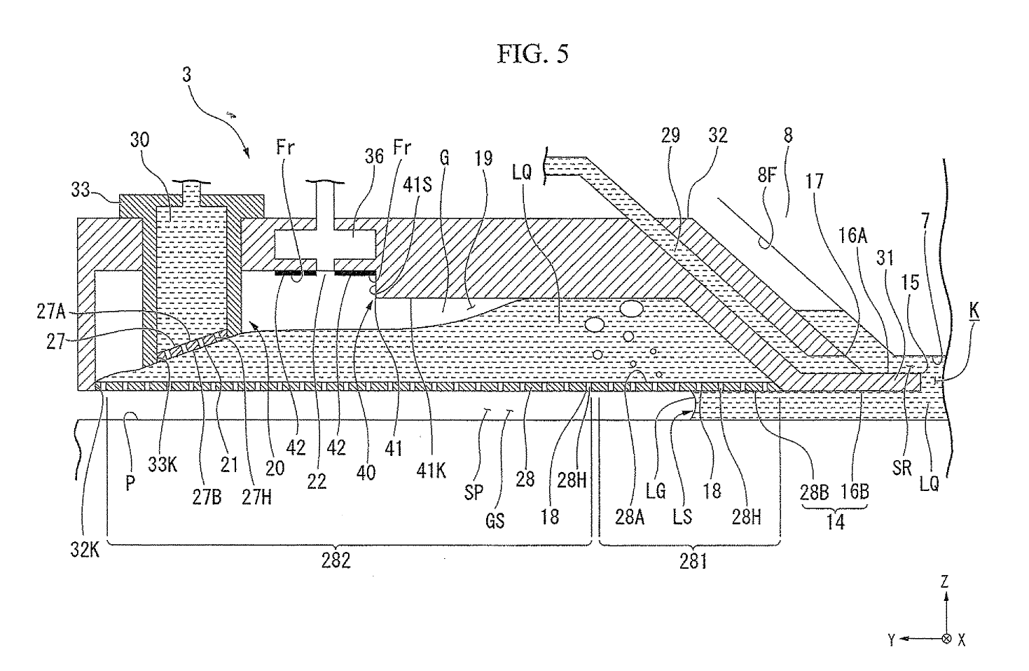

FIG. 2 is a side cross sectional view that shows one example of the liquid immersion member 3 according to the present embodiment; FIG. 3 is a view that shows the liquid immersion member 3 from the upper side (i.e., the +Z side); FIG. 4 is a view that shows the liquid immersion member 3 from the lower side (i.e., the −Z side); and FIG. 5 is a partial enlarged view of FIG. 2. The text below explains an exemplary case, referencing FIG. 2 through FIG. 5, wherein the substrate P is disposed in the projection area PR, but, for example, the substrate stage 2 (i.e., the cover member T) can also be disposed in the projection area PR as discussed above.

In the present embodiment, the liquid immersion member 3 comprises a plate part 31, at least part of which is disposed such that the plate part 31 opposes the emergent surface 7, a main body part 32, at least part of which is disposed such that the main body part 32 opposes a side surface 8F of the last optical element 8, and a passageway forming member 33. In the present embodiment, the plate part 31 and the main body part 32 are one body. In the present embodiment, the passageway forming member 33 is different from the plate part 31 and the main body part 32. In the present embodiment, the passageway forming member 33 is supported by the main body part 32. Furthermore, the passageway forming member 33, the plate part 31, and the main body part 32 may be one body.

Furthermore, the side surface 8F is disposed around the emergent surface 7. In the present embodiment, the side surface 8F is inclined upward toward the outer side in radial directions with respect to the optical path K. Furthermore, the radial directions with respect to the optical path K include the radial directions with respect to the optical axis AX of the projection optical system PL as well as the directions perpendicular to the Z axis.

The liquid immersion member 3 has an opening 15, which is formed at a position at which the opening 15 faces the emergent surface 7. The exposure light EL that emerges from the emergent surface 7 can be radiated through the opening 15 to the substrate P. In the present embodiment, the plate part 31 has an upper surface 16A, which opposes at least part of the emergent surface 7, and a lower surface 16B, which is capable of opposing the front surface of the substrate P. The opening 15 is a hole that is formed such that the opening 15 connects the upper surface 16A and the lower surface 16B. The upper surface 16A is disposed around an upper end of the opening 15 and the lower surface 16B is disposed around a lower end of the opening 15.

In the present embodiment, the upper surface 16A is flat. The upper surface 16A is substantially parallel to the XY plane. Furthermore, at least part of the upper surface 16A may be tilted with respect to the XY plane and may include a curved surface. In the present embodiment, the lower surface 16B is flat. The lower surface 16B is substantially parallel to the XY plane. Furthermore, at least part of the lower surface 16B may be tilted with respect to the XY plane and may include a curved surface. The lower surface 16B holds the liquid LQ between itself and the front surface of the substrate P.

As shown in FIG. 4, in the present embodiment, the external shape of the lower surface 16B is octagonal. Furthermore, the external shape of the lower surface 16B may be an arbitrary polygonal shape such as, for example, a quadrilateral or a hexagon. In addition, the external shape of the lower surface 16B may be circular, elliptical, and the like.

The liquid immersion member 3 has: supply ports 17, which are capable of supplying the liquid LQ; recovery ports 18, which are capable of recovering the liquid LQ; a recovery passageway 19, wherethrough the liquid LQ recovered via the recovery ports 18 flows; and discharge parts 20, which separately discharge the liquid LQ and a gas G from the recovery passageway 19.

The supply ports 17 are capable of supplying the liquid LQ to the optical path K. In the present embodiment, the supply ports 17 supply the liquid LQ to the optical path K during at least part of the exposure of the substrate P. The supply ports 17 are disposed in the vicinity of the optical path K such that they face the optical path K. In the present embodiment, the supply ports 17 supply the liquid LQ to a space SR between the emergent surface 7 and the upper surface 16A. At least some of the liquid LQ supplied to the space SR via the supply ports 17 is supplied onto the substrate P via the opening 15 as well as to the optical path K. Furthermore, at least part of at least one of the supply ports 17 may face the side surface 8F.

The liquid immersion member 3 comprises supply passageways 29, which are connected to the supply ports 17. At least part of each of the supply passageways 29 is formed inside the liquid immersion member 3. In the present embodiment, each of the supply ports 17 includes an opening, which is formed at one end of the corresponding supply passageway 29. The other end of each of the supply passageways 29 is connected to a liquid supply apparatus 35 via a passageway 34 formed by a supply piping 34P.

The liquid supply apparatus 35 is capable of supplying the liquid LQ, which is clean and temperature adjusted. The liquid LQ that is supplied from the liquid supply apparatus 35 is supplied to the supply ports 17 via the passageway 34 and the supply passageways 29. The supply ports 17 supply the liquid LQ from the supply passageways 29 to the optical path K (i.e., the space SR).

The recovery ports 18 are capable of recovering at least some of the liquid LQ from the space above the substrate P (i.e., the object). The recovery ports 18 recover at least some of the liquid LQ from the space above the substrate P during the exposure of the substrate P. The recovery ports 18 face the −Z direction. The front surface of the substrate P faces the recovery ports 18 during at least part of the exposure of the substrate P.

In the present embodiment, the liquid immersion member 3 comprises a first member 28, which has the recovery ports 18. The first member 28 has: a first surface 28B; a second surface 28A, which faces a direction other than that faced by the first surface 2813; and a plurality of holes 28H, which connect the first surface 2813 and the second surface 28A. In the present embodiment, the recovery ports 18 include the holes 28H of the first member 28. In the present embodiment, the first member 28 is a porous member that has the plurality of holes 28H (i.e., openings or pores). Furthermore, the first member 28 may be a mesh filter, which is a porous member wherein numerous small holes are formed as a mesh. Namely, a variety of members that have holes capable of recovering the liquid LQ can serve as the first member 28.

At least part of the recovery passageway 19 is formed inside the liquid immersion member 3. In the present embodiment, an opening 32K is formed in a lower end of the recovery passageway 19. The opening 32K is disposed at least partly around the lower surface 16B. The opening 32K is formed at the lower end of the main body part 32. The opening 32K faces downward (i.e., the −Z direction). In the present embodiment, the first member 28 is disposed in the opening 32K. The recovery passageway 19 includes a space between the main body part 32 and the first member 28.

The first member 28 is disposed at least partly around the optical path K (i.e., the lower surface 1613). In the present embodiment, the first member 28 is disposed around the optical path K. Furthermore, the annular first member 28 may be disposed around the optical path K (i.e., the lower surface 16B) or a plurality of the first members 28 may be disposed such that the first members 28 are distributed around the optical path K (i.e., the lower surface 16B).

In the present embodiment, the first member 28 is a plate shaped member. The first surface 288 is one surface of the first member 28 and the second surface 28A is the other surface of the first member 28. In the present embodiment, the first surface 28B faces a space SP, which is on the lower side (i.e., the −Z side) of the liquid immersion member 3. The space SP includes, for example, the space between the lower surface 14 of the liquid immersion member 3 and the front surface of the object (i.e., the substrate P and the like) that opposes the lower surface 14 of the liquid immersion member 3. If the immersion space LS is formed above the object (i.e., the substrate P and the like) opposing the lower surface 14 of the liquid immersion member 3, then the space SP includes the immersion space LS (i.e., a liquid space) and the gas space GS. In the present embodiment, the first member 28 is disposed in the opening 32K such that the first surface 28B faces the space SP and the second surface 28A faces the recovery passageway 19. In the present embodiment, the first surface 2813 and the second surface 28A are substantially parallel. The first member 28 is disposed in the opening 32K such that the second surface 28A faces the +Z direction and the first surface 28B faces the opposite direction (i.e., the −Z direction) to that faced by the second surface 28A. In addition, in the present embodiment, the first member 28 is disposed in the opening 32K such that the first surface 28B and the second surface 28A are substantially parallel to the XY plane.

In the explanation below, the first surface 28B is called the lower surface 28B where appropriate, and the second surface 28A is called the upper surface 28A where appropriate.

Furthermore, the first member 28 does not have to be plate shaped. In addition, the lower surface 28B and the upper surface 28A may be nonparallel. In addition, at least part of the lower surface 28B may be tilted with respect to the XY plane and may include a curved surface. In addition, at least part of the upper surface 28A may be tilted with respect to the XY plane and may include a curved surface.

The holes 28H are formed such that they connect the lower surface 28B and the upper surface 28A. The fluid (i.e., the fluid containing the gas G or the liquid LQ, or both) is capable of passing through the holes 28H of the first member 28. In the present embodiment, the recovery ports 18 include the openings at the lower ends of the holes 28H on the lower surface 28B side. The lower surface 28B is disposed around the lower ends of the holes 28H, and the upper surface 28A is disposed around the upper ends of the holes 28H.

The recovery passageway 19 is connected to the holes 28H (i.e., the recovery ports 18) of the first member 28. The first member 28 recovers at least some of the liquid LQ from the space above the substrate P (i.e., the object) opposing the lower surface 28B via the holes 28H (i.e., the recovery ports 18). The liquid LQ recovered via the holes 28H of the first member 28 flows through the recovery passageway 19.

In the present embodiment, the lower surface 14 of the liquid immersion member 3 includes the lower surface 1613 and the lower surface 28B. In the present embodiment, the lower surface 28B is disposed at least partly around the lower surface 16B. In the present embodiment, the annular lower surface 2813 is disposed around the lower surface 1613. Furthermore, a plurality of the lower surfaces 2813 may be disposed such that the lower surfaces 28B are distributed around the lower surface 16B (i.e., the optical path K).

In the present embodiment, the first member 28 comprises a first portion 281 and a second portion 282. In the present embodiment, the second portion 282 is disposed on the outer side of the first portion 281 in radial directions with respect to the optical path K. In the present embodiment, the second portion 282 hinders the flow of the gas G from the space SP into the recovery passageway 19 via the holes 28H more than the first portion 281 does.

In the present embodiment, the inflow resistance of the gas G from the space SP into the recovery passageway 19 via the holes 28H is greater at the second portion 282 than at the first portion 281.

The first portion 281 and the second portion 282 each have a plurality of the holes 28H. For example, in the state wherein the immersion space LS is being formed in the space SP, some of the holes 28H among the plurality of the holes 28H of the first portion 281 might contact the liquid LQ in the immersion space LS and some might not.

In addition, some of the holes 28H among the plurality of the holes 28H of the second portion 282 might contact the liquid LQ in the immersion space LS and some might not.

In the present embodiment, the first portion 281 is capable of recovering the liquid LQ to the recovery passageway 19 via the holes 28H that contact the liquid LQ in the space SP (i.e., the liquid LQ in the space above the substrate P). In addition, the first portion 281 suctions the gas G into the recovery passageway 19 via the holes 28H that do not contact the liquid LQ.

Namely, the first portion 281 is capable of recovering the liquid LQ in the immersion space LS to the recovery passageway 19 via the holes 28H that face the immersion space LS, and the first portion 281 suctions the gas G into the recovery passageway 19 via the holes 28H that face the gas space GS on the outer side of the immersion space LS.

In other words, the first portion 281 is capable of recovering the liquid LQ in the immersion space LS to the recovery passageway 19 via the holes 28H that face the immersion space LS, and the first portion 281 suctions the gas G into the recovery passageway 19 via the holes 28H that do not face the immersion space LS.

Namely, if the interface LG of the liquid LQ in the immersion space LS is present between the first portion 281 and the substrate P, then the first portion 281 recovers to the recovery passageway 19 the liquid LQ together with the gas G. Furthermore, at the interface LG, both the liquid LQ and the gas G may be suctioned via the holes 2814 that face both the immersion space LS and the gas space GS.

The second portion 282 is capable of recovering the liquid LQ to the recovery passageway 19 via the holes 28H that contact the liquid LQ in the space SP (i.e., the liquid LQ in the space above the substrate P). In addition, the second portion 282 hinders the flow of the gas G into the recovery passageway 19 via the holes 28H that do not contact the liquid LQ.

Namely, the second portion 282 is capable of recovering the liquid LQ in the immersion space LS to the recovery passageway 19 via the holes 28H that face the immersion space LS, and the second portion 282 hinders the flow of the gas G into the recovery passageway 19 via the holes 28H that face the gas space GS, which is disposed on the outer side of the immersion space LS.

In the present embodiment, the second portion 282 recovers substantially only the liquid LQ, and not the gas G, to the recovery passageway 19.

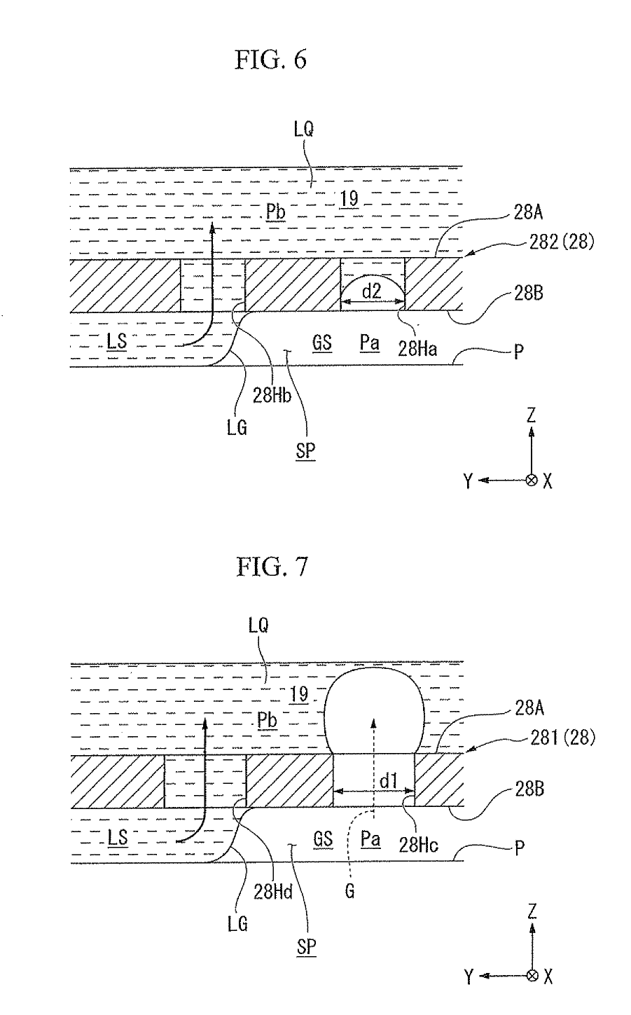

FIG. 6 is a partial enlarged cross sectional view of the second portion 282 of the first member 28 and serves as a schematic drawing for explaining one example of the state wherein the second portion 282 is recovering only the liquid LQ.

In FIG. 6, there is a difference between a pressure Pa in the space SP (i.e., the gas space GS) and a pressure Pb in the recovery passageway 19. In the present embodiment, the pressure Pb in the recovery passageway 19 is lower than the pressure Pa in the space SP. When the liquid LQ is being recovered from the space above the substrate P (i.e., the object) via the first member 28, the liquid LQ is recovered from the space above the substrate P to the recovery passageway 19 via a hole 28Hb of the second portion 282, and the flow of the gas G into the recovery passageway 19 via a hole 28Ha of the second portion 282 is hindered.

In FIG. 6, the immersion space LS (i.e., the liquid space) and the gas space GS are formed in the space SP between the lower surface 28B of the second portion 282 and the front surface of the substrate P. In FIG. 6, the space that the lower end of the hole 28Ha of the second portion 282 faces is the gas space GS, and the space that the lower end of the hole 28Hb of the second portion 282 faces is the immersion space LS (i.e., the liquid space). In addition, in FIG. 6, the liquid LQ in the recovery passageway 19 (i.e., a liquid space) is present on the upper side of the second portion 282.

In the present embodiment, the liquid LQ is recovered from the space above the substrate P to the recovery passageway 19 via the hole 281-1b of the second portion 282, which contacts the liquid LQ, and the flow of the gas G into the recovery passageway 19 via the hole 28Ha of the second portion 282, which does not contact the liquid LQ, is hindered.

In FIG. 6, the condition below is satisfied.

(4×γ×cos θ2)/d2≧(Pb−Pa) (1)

Therein, Pa is the pressure in the gas space GS that the lower end of the hole 28Ha faces (i.e., the pressure on the lower surface 28B side), Pb is the pressure in the recovery passageway 19 (i.e., the liquid space) on the upper side of the first member 28 (i.e., the pressure on the upper surface 28A side), d2 is the dimension (i.e., the pore size or the diameter) of each of the holes 28Ha, 28Hb, θ2 is the contact angle of the liquid LQ with respect to the surface (i.e., the inner surface) of each of the holes 28H of the second portion 282, and γ is the surface tension of the liquid LQ. Furthermore, to simplify the explanation, the condition expressed in the abovementioned equation (1) does not take the hydrostatic pressure of the liquid LQ on the upper side of the first member 28 into consideration.

Furthermore, in the present embodiment, the dimension d2 of each of the holes 28H of the second portion 282 indicates the minimum value thereof of all of the holes 28H between the upper surface 28A and the lower surface 2813. Furthermore, the dimension d2 does not have to be the minimum dimension of all of the holes 28H between the upper surface 28A and the lower surface 2813, and may be, for example, the average value or the maximum value thereof.

In this case, the contact angle θ2 of the liquid LQ with respect to the surface of each of the holes 28H of the second portion 282 satisfies the condition below.

θ2≦90° (2)

If the above condition holds, then, even if the gas space GS is formed on the lower side (i.e., on the space SP side) of the hole 28Ha of the first member 28, the gas G in the gas space GS on the lower side of the first member 28 is hindered from moving to (i.e., flowing into) the recovery passageway 19 (i.e., the liquid space) on the upper side of the first member 28 via the hole 28Ha. Namely, if the dimension d2 (i.e., the pore size or diameter) of the holes 28H of the second portion 282, the contact angle θ2 (i.e., the affinity) of the liquid LQ with respect to the surface of each of the holes 28H of the second portion 282, the surface tension γ of the liquid LQ, and the pressures Pa, Pb satisfy the above condition, then the interface between the liquid LQ and the gas G is kept on the inner side of the hole 28Ha and the flow of the gas G from the space SP into the recovery passageway 19 via the hole 28Ha of the second portion 282 is hindered. Moreover, because the immersion space LS (i.e., the liquid space) is formed on the lower side (i.e., on the space SP side) of the hole 28Hb, only the liquid LQ is recovered via the hole 28Hb.

In the present embodiment, the above condition is satisfied for all of the holes 28H of the second portion 282, and substantially only the liquid LQ is recovered via the holes 28H of the second portion 282.

In the explanation below, the state wherein only the liquid LQ is recovered via the holes of the porous member (e.g., the holes 28H of the first member 28) is called a liquid selective recovery state where appropriate, and the condition wherein only the liquid LQ is recovered via the holes of the porous member is called a liquid selective recovery condition where appropriate.

FIG. 7 is a partial enlarged cross sectional view of the first portion 281 of the first member 28 and serves as a schematic drawing for explaining one example of the state wherein the first portion 281 is recovering the liquid LQ and the gas G.

In FIG. 7, there is a difference between the pressure Pa in the space SP (i.e., the gas space GS) and the pressure Pb in the recovery passageway 19. In the present embodiment, when the pressure Pb in the recovery passageway 19 is lower than the pressure Pa in the space SP and when the liquid LQ is being recovered from the space above the substrate P (i.e., the object) via the first member 28, the gas G is suctioned into the recovery passageway 19 via a hole 28Hc of the first portion 281.

In FIG. 7, the immersion space LS (i.e., the liquid space) and the gas space GS are formed in the space SP. In FIG. 7, the space that the lower end of the hole 28Hc of the first portion 281 faces is the gas space GS, and the space that the lower end of a hole 28Hd of the first portion 281 faces is the immersion space LS (i.e., the liquid space). In addition, in FIG. 7, the liquid LQ in the recovery passageway 19 (i.e., the liquid space) is present on the upper side of the first portion 281.

In the present embodiment, the liquid LQ is recovered from the space above the substrate P to the recovery passageway 19 via the hole 28Hd of the first portion 281, which contacts the liquid LQ, and the gas G is suctioned into the recovery passageway 19 via the hole 28Hc of the first portion 281, which does not contact the liquid LQ.

In the present embodiment, the dimension (i.e., the pore size or the diameter) of each of the holes 28H or a contact angle θ1 of the liquid LQ with respect to the surface (i.e., the inner surface) of each of the holes 28H, or both, is different at the first portion 281 than it is at the second portion 282. Owing to the difference between the pressure Pa in the space SP (i.e., the gas space GS) and the pressure Pb in the recovery passageway 19, the liquid LQ is recovered from the space above the substrate P to the recovery passageway 19 via the hole 28Hd of the first portion 281, which contacts the liquid LQ, and the gas G is suctioned into the recovery passageway 19 via the hole 28Hc of the first portion 281, which does not contact the liquid LQ.

Furthermore, in the present embodiment, a dimension d1 of each of the holes 28H of the first portion 281 indicates the minimum value thereof of all of the holes 28H between the upper surface 28A and the lower surface 28B. Furthermore, the dimension d1 does not have to be the minimum dimension of all of the holes 28H between the upper surface 28A and the lower surface 2813, and may be, for example, the average value or the maximum value thereof.

In the present embodiment, the surface of each of the holes 28H of the second portion 282 is more lyophilic with respect to the liquid LQ than the surface of each of the holes 28H of the first portion 281 is. Namely, the contact angle θ2 of the liquid LQ with respect to the surface (i.e., the inner surface) of each of the holes 28H of the second portion 282 is smaller than the contact angle θ1 of the liquid LQ with respect to the surface (i.e., the inner surface) of each of the holes 28H of the first portion 281. Thereby, the first portion 281 recovers the liquid LQ together with the gas G, and the second portion 282 recovers the liquid LQ while hindering the flow of the gas G into the recovery passageway 19.

In the present embodiment, the contact angle θ2 of the liquid LQ with respect to the surface of each of the holes 28H of the second portion 282 is less than 90°. For example, the contact angle θ2 of the liquid LQ with respect to the surface of each of the holes 28H of the second portion 282 may be less than 50°, less than 40°, less than 30°, or less than 20°.

Furthermore, the dimension d1 of each of the holes 28H of the first portion 281 may be different from the dimension d2 of each of the holes 28H of the second portion 282. For example, by making the dimension d2 of each of the holes 28H of the second portion 282 smaller than the dimension d1 of each of the holes 28H of the first portion 281, the first portion 281 recovers the liquid LQ together with the gas G, and the second portion 282 recovers the liquid LQ while hindering the flow of the gas G into the recovery passageway 19.

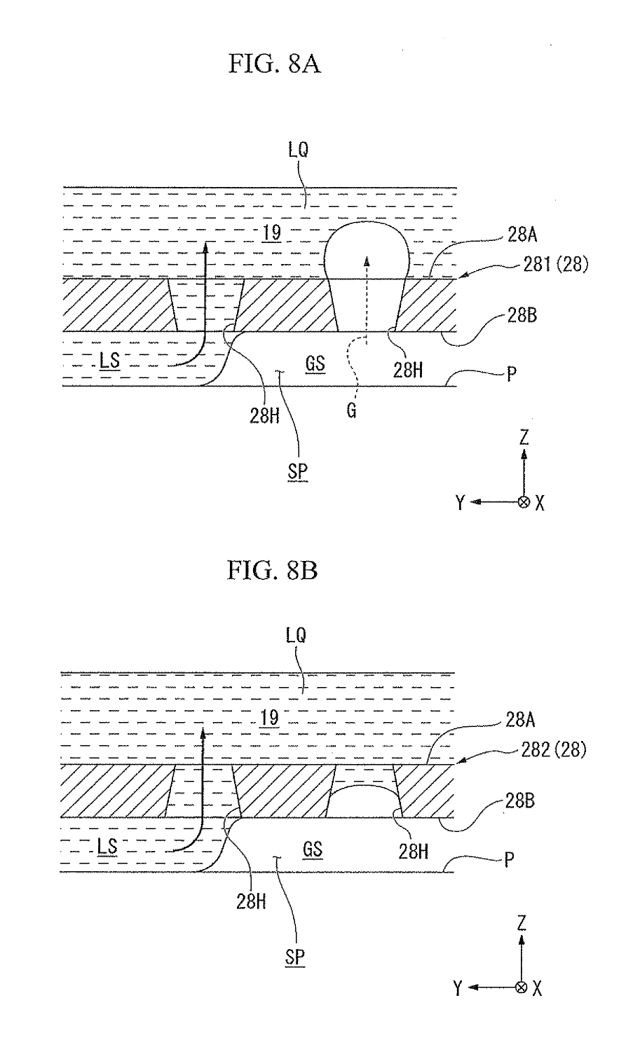

In addition, as shown in, for example, FIGS. 5A and 8B, the cross sectional shape of the holes 28H of the first portion 281 within the YZ plane may be different from that of the holes 28H of the second portion 282. For example, the inclination angle of the inner surface of each of the holes 28H of the first portion 281 and the inclination angle of the inner surface of each of the holes 28H of the second portion 282 may be different such that the contact angle of the liquid LQ with respect to the inner surface of each of the holes 28H of the second portion 282 is substantially larger than the contact angle of the liquid LQ with respect to the inner surface of each of the holes 28H of the first portion 281. Furthermore, the inclination angle of each of the holes 28H indicates the inclination angle along the Z axis. Furthermore, conceptually, the inclination angle of each of the holes 28H may be the tilt angle with respect to the XY plane, which is substantially parallel to the front surface of the substrate P (i.e., the object).

FIG. 8A is a schematic drawing that shows one example of the holes 28H of the first portion 281, and FIG. 8B is a schematic drawing that shows one example of the holes 28H of the second portion 282. As shown in FIG. 8A and FIG. 8B, for example, each of the holes 28H of the first portion 281 may be formed such that it widens proceeding from the lower surface 28B to the upper surface 28A, and each of the holes 28H of the second portion 282 may be formed such that it widens proceeding from the upper surface 28A to the lower surface 28B. The contact angle of the liquid LQ with respect to the inner surface of each of the holes 28H substantially varies with the inclination angle of the inner surface of each of the holes 28H. Accordingly, the inclination angle of the inner surface of each of the holes 28H may be determined such that the flow of the gas G from the space SP into the recovery passageway 19 via the holes 28H of the second portion 282 is hindered more than the flow of the gas G from the space SP into the recovery passageway 19 via the holes 28H of the first portion 281. In the example shown in FIGS. 8A and 8B, the first portion 281 recovers the liquid LQ together with the gas G, and the second portion 282 recovers the liquid LQ while hindering the flow of the gas G into the recovery passageway 19.

In addition, in the present embodiment, the liquid recovery capacity per unit of area of the lower surface 28B may be higher at the first portion 281 than at the second portion 282. In this case, the amount of the liquid LQ that flows from the space SP to the recovery passageway 19 via the holes 28H of the first portion 281 may be greater than the amount of the liquid LQ that flows from the space SP to the recovery passageway 19 via the holes 28H of the second portion 282.

The text below explains the discharge parts 20, referencing FIG. 2 through FIG. 5. Each of the discharge parts 20 has first discharge ports 21, which face the recovery passageway 19 and are for discharging the liquid LQ from the recovery passageway 19, and a second discharge port 22, which faces the recovery passageway 19 and is for discharging the gas G from the recovery passageway 19.

In the present embodiment, the first discharge ports 21 are disposed above (i.e., in the +Z direction of) the recovery ports 18 such that the first discharge ports 21 face the recovery passageway 19. The second discharge ports 22 are disposed above (i.e., in the +Z direction of) the recovery ports 18 such that the second discharge ports 22 face the recovery passageway 19.

In the present embodiment, the first discharge ports 21 or the second discharge ports 22, or both, face downward (i.e., in the −Z direction). In the present embodiment, the first discharge ports 21 and the second discharge ports 22 each face downward.

In the present embodiment, the first discharge ports 21 are disposed on the outer side of the second discharge ports 22 in radial directions with respect to the optical path K. Namely, in the present embodiment, the first discharge ports 21 are farther from the optical path K than the second discharge ports 22 are.

In the present embodiment, at least part of at least one of the first discharge ports 21 opposes the upper surface 28A of the second portion 282 of the first member 28. In the present embodiment, all of each of the first discharge ports 21 opposes the upper surface 28A of the second portion 282. The first discharge ports 21, which oppose the first member 28, oppose the recovery ports 18.

In the present embodiment, at least part of at least one of the second discharge ports 22 oppose the upper surface 28A of the second portion 282 of the first member 28. In the present embodiment, all of the second discharge ports 22 oppose the upper surface 28A of the second portion 282. The second discharge ports 22, which oppose the first member 28, oppose the recovery ports 18.

In the present embodiment, the first discharge ports 21 are disposed below the second discharge ports 22.

In addition, in the present embodiment, the second discharge ports 22 are disposed more spaced apart from the upper surface 28A of the first member 28 than the first discharge ports 21 are.

In addition, in the present embodiment, at least part of the second portion 282 is disposed on the outer side of the first discharge ports 21 and the second discharge ports 22 in the radial directions with respect to the optical path K. Namely, in the present embodiment, at least part of the second portion 282 is farther from the optical path K than the first discharge ports 21 and the second discharge ports 22 are. In the example shown in FIG. 5, an outer edge of the second portion 282 is disposed on the outer side of the first discharge ports 21 and the second discharge ports 22 in the radial directions with respect to the optical path K.

In addition, in the present embodiment, at least part of the first portion 281 of the first member 28 is disposed on the inner side of the first discharge ports 21 and the second discharge ports 22 in the radial directions with respect to the optical path K. Namely, in the present embodiment, at least part of the first portion 281 is closer to the optical path K than the first discharge ports 21 and the second discharge ports 22 are. In the example shown in FIG. 5, substantially the entire first portion 281 is disposed on the inner side of the first discharge ports 21 and the second discharge ports 22 in the radial directions with respect to the optical path K.

As discussed above, the first member 28 (i.e., the first portion 281) recovers the liquid LQ together with the gas G from the space SP to the recovery passageway 19. The liquid LQ and the gas G in the space SP between the substrate P and the first member 28 flow to the recovery passageway 19 via the first member 28. As shown in FIG. 2 and FIG. 5, a gas space and the liquid space are formed in the recovery passageway 19. The first discharge ports 21 discharge the liquid LQ from the recovery passageway 19, and the second discharge ports 22 discharge the gas G from the recovery passageway 19.

In the present embodiment, the first discharge ports 21 hinder the inflow of the gas G more than the second discharge ports 22 do. The second discharge ports 22 hinder the inflow of the liquid LQ more than the first discharge ports 21 do. In the present embodiment, the percentage of the liquid LQ in the fluid discharged via the first discharge ports 21 is greater than the percentage of the liquid LQ in the fluid discharged via the second discharge ports 22. In the present embodiment, the percentage of the gas G in the fluid discharged via the first discharge ports 21 is less than the percentage of the gas G in the fluid discharged via the second discharge ports 22.

In the present embodiment, the first discharge ports 21 discharge substantially only the liquid LQ from the recovery passageway 19. The second discharge ports 22 discharge substantially only the gas G from the recovery passageway 19.

In the present embodiment, the second discharge ports 22 are provided in the main body part 32 of the immersion member 3. Moreover, in the present embodiment, the liquid immersion member 3 comprises second members 27, which have the first suction ports 21. Each of the second members 27 has: a third surface 2713, which faces the recovery passageway 19; a fourth surface 27A, which faces a direction other than that faced by the third surface 27B; and multiple holes 27H, which connect the third surface 27B and the fourth surface 27A. In the present embodiment, the first discharge ports 21 include the holes 27H of the second members 27. In the present embodiment, each of the second members 27 is a porous member that has the multiple holes 27H. Furthermore, each of the second members 27 may be a mesh filter, which is a porous member wherein numerous small holes are formed as a mesh. Namely, a variety of members that have holes capable of hindering the inflow of the gas G can serve as each of the second members 27.

In the present embodiment, openings 33K are formed at the lower end of the passageway forming member 33. The opening 33K faces downward (i.e., the direction). In the present embodiment, the second members 27 are disposed in the openings 33K.

In the present embodiment, the second members 27 are plate shaped members. Each of the third surfaces 27B is one surface of the corresponding second member 27, and each of the fourth surfaces 27A is the other surface of the corresponding second member 27. In the present embodiment, the second members 27 are disposed in the openings 33K such that the third surfaces 2713 face the recovery passageway 19 and the fourth surfaces 27A face passageways 30 of the passageway forming member 33. In the present embodiment, the third surfaces 27B and the fourth surfaces 27A are substantially parallel. The second members 27 are disposed in the openings 33K such that the fourth surfaces 27A face the +Z direction and the third surfaces 27B face the opposite direction (i.e., the −Z direction) to that faced by the fourth surfaces 27A. In addition, in the present embodiment, the second members 27 are disposed in the openings 33K such that the third surfaces 27B and the fourth surfaces 27A are substantially parallel to the XY plane.

In the explanation below, the third surfaces 27B are called the lower surfaces 27B where appropriate, and the fourth surfaces 27A are called the upper surfaces 27A where appropriate.

Furthermore, the second members 27 do not have to be plate shaped members. In addition, the lower surface 27B and the upper surface 27A may be nonparallel. In addition, at least part of the lower surface 27B may be tilted with respect to the XY plane and may include a curved surface. In addition, at least part of the upper surface 27A may be tilted with respect to the XY plane and may include a curved surface.

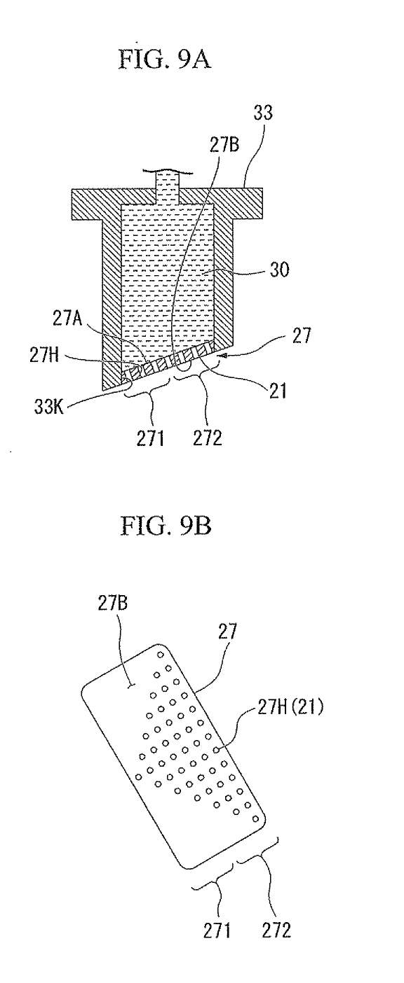

FIG. 9A is a side cross sectional view of the vicinity of the second member 27, and FIG. 9B is a diagram of the second member 27, viewed from the lower surface 27B side.

In FIG. 9, the second member 27 has a third portion 271 and a fourth portion 272, which is disposed at a position higher than the third portion 271 and is capable of discharging a greater amount of the liquid LQ than the third portion 271 is. The liquid LQ in the recovery passageway 19 is discharged via the first discharge ports 21 in the third portion 271 or the first discharge ports 21 in the fourth portion 272, or both.

The liquid LQ discharge capacity per unit of area of the lower surface 27B of the second member 27 is higher at the fourth portion 272 than at the third portion 271. Namely, the amount of liquid LQ discharged per unit of area is larger at the fourth portion 272 than at the third portion 271. As shown in FIG. 9B, the percentage of the first discharge ports 21 (i.e., the holes 27H) per unit of area in the lower surface 27B is larger in the fourth portion 272 than in the third portion 271. In addition, the number of the first discharge ports 22 (i.e., the holes 27H) in the fourth portion 272 is larger than the number of the first discharge ports 22 (i.e., the holes 27H) in the third portion 271. The fourth portion 272 is disposed more spaced apart from the upper surface 28A of the first member 28 than the third portion 271 is. In the present embodiment, the fourth portion 272 is nearer the optical path K than the third portion 271 is. In the present embodiment, at least part of the lower surface 27B of the second member 27 is nonparallel to the XY plane (i.e., the horizontal plane). An upper surface 27A faces a direction other than that faced by the lower surface 2713. In the present embodiment, the upper surface 27A faces the opposite direction to that faced by the lower surface 27B. In the present embodiment, the upper surface 27A and the lower surface 2713 of the second member 27 are inclined surfaces that are inclined downward in the radial directions with respect to the optical path K. Furthermore, the fourth portion 272 may be farther from the optical path K than the third portion 271 is.

The holes 27H are disposed such that they connect each of the lower surfaces 27B to the corresponding upper surface 27A. The fluid (i.e., the fluid containing the liquid LQ or the gas G, or both) can flow through the holes 27H of the second members 27. In the present embodiment, each of the first discharge ports 21 is disposed at the lower ends of the holes 27H on the corresponding lower surface 2713 side. In other words, the first discharge ports 21 are the openings at the lower ends of the holes 27H. Each of the lower surfaces 27B is disposed around the lower ends of the corresponding holes 27H, and each of the upper surfaces 27A is disposed around the upper ends of the corresponding holes 27H.

Each of the passageways 30 are connected to the holes 27H (i.e., the first discharge ports 21) of the corresponding second member 27. The second members 27 discharge at least some of the liquid LQ from the recovery passageway 19 via the holes 27H (i.e., the first discharge ports 21). The liquid LQ discharged via the holes 27H of the second members 27 flows through the passageways 30.

In the present embodiment, the pressure differential between the recovery passageway 19 that the lower surfaces 27B face and the passageways 30 (i.e., the spaces) that the upper surfaces 27A face is adjusted such that the discharge of the gas G via the first discharge ports 21 is hindered.

In the present embodiment, the second members 27 discharge substantially only the liquid LQ, and not the gas G, to the passageways 30.

In the present embodiment, when the liquid LQ is being recovered from the space above the substrate P (i.e., the object) via the first member 28, the difference between the pressure Pb in the recovery passageway 19, which the lower surfaces 27B of the second members 27 face, and a pressure Pc in the passageways 30, which the upper surfaces 27A of the second members 27 face, is adjusted such that the liquid LQ is discharged from the recovery passageway 19 to the passageways 30 via the holes 27H of the second members 27 and the gas G is hindered from flowing into the passageways 30 via the holes 27H of the second members 27.

In the present embodiment, the difference between the pressure Pb in the recovery passageway 19 and the pressure Pc in the passageways 30 is prescribed such that the liquid LQ in the recovery passageway 19 is recovered to the passageways 30 via the holes 27Hb of the second members 27 that contact the liquid LQ and the gas G is hindered from flowing into the passageways 30 via the holes 27Ha of the second members 27 that do not contact the liquid LQ.

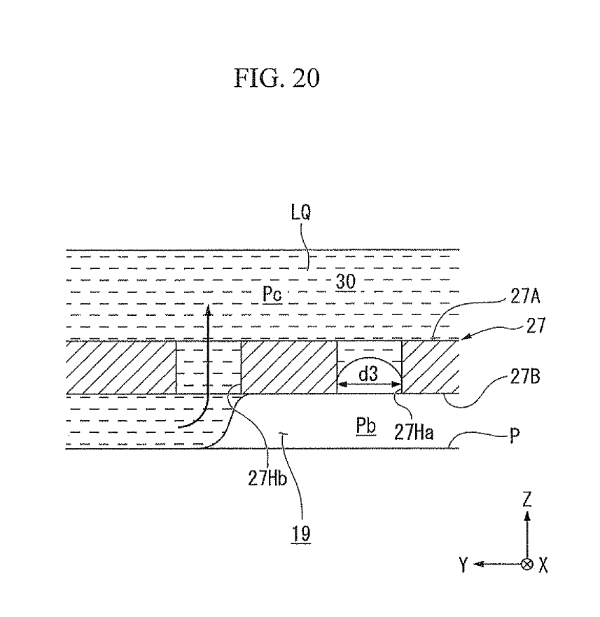

In the present embodiment, the recovery condition (i.e., the discharge condition) of the liquid LQ via the holes 27H of the second members 27 satisfies the liquid selective recovery condition, as explained referencing FIG. 6 and the like. Namely, as shown in FIG. 20, by making the dimension d3 (i.e., the pore size or diameter) of each of the holes 27H of the second members 27, the contact angle θ3 (i.e., the affinity) of the liquid LQ with respect to the surface of each of the holes 27H of the second members 27, the surface tension γ of the liquid LQ, the pressure Pb in the recovery passageway 19 that the lower surfaces 27B face, and the pressure Pc in the passageways 30 that the upper surfaces 27A face satisfy the liquid recovery option condition, the interface between the liquid LQ and the gas G is kept on the inner side of the holes 27H and the flow of the gas G from the recovery passageway 19 into the passageways 30 via the holes 27H of the second members 27 is hindered. Thereby, the second members 27 (i.e., the first discharge ports 21) can discharge substantially only the liquid LQ.

Furthermore, in the present embodiment, the dimension d3 of each of the holes 27H of the second members 27 indicates the minimum value thereof of all of the holes 27H between each of the upper surfaces 27A and the corresponding lower surface 27B. Furthermore, the dimension d3 does not have to be the minimum dimension of all of the holes 27H between each of the upper surfaces 27A and the corresponding lower surface 27B, and may be, for example, the average value or the maximum value thereof.

In the present embodiment, the difference between the pressure Pb in the recovery passageway 19 and the pressure Pc in the passageways 30 is adjusted such that the recovery condition (i.e., the discharge condition) of the liquid LQ via the holes 27H of the second members 27 is the liquid selective recovery condition. The pressure Pc is lower than the pressure Pb. Namely, the difference between the pressure Pb in the recovery passageway 19 and the pressure Pc in the passageways 30 is prescribed such that the liquid LQ in the recovery passageway 19 is discharged to the passageways 30 via the holes 27H of the second members 27 and the gas G is hindered from flowing into the passageways 30 via the holes 27H of the second members 27. By adjusting the pressure Pb or the pressure Pc, or both, the second members 27 discharge substantially only the liquid LQ, and not the gas G, to the passageways 30 via the holes 27H. In the present embodiment, at least part of the surface of each of the second members 27 is lyophilic with respect to the liquid LQ. In the present embodiment, at least the surfaces (i.e., the inner surfaces) of the holes 27H of the second members 27 are lyophilic with respect to the liquid LQ. In the present embodiment, the contact angle of the liquid LQ with respect to the surface of each of the holes 27H is 90° or less. Furthermore, the contact angle of the liquid LQ with respect to the surface of each of the holes 27H may be less than 50°, less than 40°, less than 30°, or less than 20°.

As shown in FIG. 5 and the like, in the present embodiment, the liquid immersion member 3 comprises a hindering part 40, which is disposed inside the recovery passageway 19 and hinders the liquid LQ in the recovery passageway 19 from contacting the second discharge ports 22. The hindering part 40 is provided in the recovery passageway 19 such that the second discharge ports 22 are disposed in the gas space of the recovery passageway 19. Namely, the hindering part 40 is provided in the recovery passageway 19 such that the peripheral space of each of the second discharge ports 22 in the recovery passageway 19 is the gas space. For example, the hindering part 40 adjusts the interface (i.e., the surface) of the liquid space in the recovery passageway 19 such that the liquid LQ does not contact the second discharge ports 22. Thereby, the second discharge ports 22 disposed in the gas space discharge substantially only the gas G from the recovery passageway 19.

In the present embodiment, the hindering part 40 comprises a projection 41, which is disposed at least partly around the second discharge ports 22. The projection 41 is provided inside the recovery passageway 19 such that the second discharge ports 22 are disposed in the gas space in the recovery passageway 19. The projection 41 limits the movement of the interface of the liquid space in the recovery passageway 19 such that the second discharge ports 22 are disposed in the gas space in the recovery passageway 19. Namely, the projection 41 hinders the interface of the liquid space in the recovery passageway 19 from approaching the second discharge ports 22.

In addition, in the present embodiment, the hindering part 40 comprises a liquid repellent part 42, which is disposed inside the recovery passageway 19 at least partly around the second discharge ports 22 and whose surface is liquid repellent with respect to the liquid LQ. The liquid repellent part 42 hinders contact between the second discharge ports 22 and the liquid LQ in the recovery passageway 19. The liquid repellent part 42 is provided inside the recovery passageway 19 such that the second discharge ports 22 are disposed in the gas space in the recovery passageway 19. The liquid repellent part 42 hinders the interface of the liquid space in the recovery passageway 19 from approaching the second discharge ports 22 such that the peripheral space of each of the second discharge ports 22 inside the recovery passageway 19 is the gas space.

In the present embodiment, the second discharge ports 22 are disposed on the outer side of the projection 41 in radial directions with respect to the optical path K. Namely, the second discharge ports 22 are farther from the optical path K than the projection 41 is. In addition, at least part of the liquid repellent part 42 is disposed between the second discharge ports 22 and the projection 41.

In the present embodiment, the projection 41 is disposed between the second discharge ports 22 and at least some of the recovery ports 18 in the radial directions with respect to the optical path K. In the present embodiment, the projection 41 is disposed between the recovery ports 18 of the first portion 281 and the second discharge ports 22 in the radial directions with respect to the optical path K.

The projection 41 projects downward at least partly around the second discharge ports 22. In the present embodiment, the projection 41 is formed by at least part of the inner surface of the recovery passageway 19. In the present embodiment, the surfaces of the projection 41 include a side surface 41S, which extends downward at least partly around the second discharge ports 22, and a lower surface 41K, which extends from a lower end part of the side surface 41S such that it approaches the optical path K proceeding from the inner sides of the second discharge ports 22. The side surface 41S faces the outer side in the radial directions with respect to the optical path K. The side surface 41S is substantially parallel to the optical path K. The side surface 41S is substantially parallel to the Z axis. Furthermore, the side surface 41S does not have to be parallel to the Z axis. The lower surface 41K faces the −Z direction. In the present embodiment, the lower surface 41K is substantially parallel to the XY plane. The side surface 41S and the lower surface 41K are part of the inner surface of the recovery passageway 19. In the present embodiment, the angle formed between the lower surface 41K and the side surface 41S is substantially 90°. Furthermore, the angle formed between the lower surface 41K and the side surface 41S may be less than or greater than 90°. In the present embodiment, the tip (i.e., the lower end) of the projection 41 is disposed at a position that is lower than the second discharge ports 22.

In the present embodiment, the lower surface 41K and the side surface 415 of the inner surface of the recovery passageway 19, which form the projection 41, are lyophilic with respect to the liquid LQ. In the present embodiment, the lyophilic lower surface 41K and the lyophilic side surface 41S are adjacent to the liquid repellent part 42. At least part of the liquid repellent part 42 is disposed between the lyophilic lower surface 41K and the lyophilic side surface 41S on one side and the second discharge ports 22 on the other side.

In the present embodiment, the contact angle of the liquid LQ with respect to the lyophilic inner surface (i.e., the lower surface 41K and the side surface 41S) of the recovery passageway 19 is less than 90°. The contact angle of the liquid LQ with respect to the surface of the liquid repellent part 42 is 90° or greater. In the present embodiment, the contact angle of the liquid LQ with respect to the surface of the liquid repellent part 42 may be, for example, 100° or greater or 110° or greater.

In the present embodiment, the liquid repellent part 42 is formed with films Fr that are liquid repellent with respect to the liquid LQ. The material used to form the films Fr is fluorine based. In the present embodiment, the films Fr are tetrafluoroethylene-perfluoro (alkyl vinyl ether) copolymer (PFA) films. Furthermore, the films Fr may also be, for example, polytetrafluoroethylene (PTFE) films, polyetheretherketone (PEEK) films, or Teflon® films. In addition, the films Fr may also be Cytop™ (made by Asahi Glass Co.) or Novec EGC™ (made by 3M Company) films.

Furthermore, the hindering part 40 does not have to comprise the liquid repellent part 42.

In the present embodiment, the first discharge ports 21 and the second discharge ports 22 are disposed at least partly around the optical path K. As shown in FIG. 3, in the present embodiment, the second members 27, which each have the first discharge ports 21, are disposed at prescribed intervals around the optical path K. In the present embodiment, the second members 27 are disposed at four locations around the optical path K. The second discharge ports 22 are disposed at prescribed intervals around the optical path K. Furthermore, the number of the first discharge ports 21 and the number of the second discharge ports 22 may be the same. Furthermore, the first discharge ports 21 may be provided continuously around the optical path K, the second discharge ports 22 may be provided continuously around the optical path K, or both may be so provided.

As shown in FIG. 2, each of the first discharge ports 21 is connected to a first discharge apparatus 24 via the corresponding passageway 30 and a passageway 23, which is formed by a discharge piping 23P. The second discharge ports 22 are connected to a second discharge apparatus 26 via a passageway 36, which is formed inside the main body part 32, and a passageway 25, which is formed by a discharge piping 25P. Each of the first and second discharge apparatuses 24, 26 comprises, for example, a vacuum system and is capable of suctioning the fluid (i.e., the fluid containing the gas G or the liquid LQ, or both).

In the present embodiment, a discharge operation is performed via the first discharge ports 21 by the operation of the first discharge apparatus 24. In addition, in the present embodiment, a discharge operation is performed via the second discharge ports 22 by the operation of the second discharge apparatus 26.

In the present embodiment, the first discharge apparatus 24 is capable of adjusting the pressure Pc in the passageways 30 that the upper surfaces 27A of the second members 27 face. In addition, the second discharge apparatus 26 is capable of adjusting the pressure Pb in the recovery passageway 19 that the lower surfaces 27B of the second members 27 and the upper surface 28A of the first member 28 face. In addition, the internal space CS includes the space SP, and the chamber apparatus CH is capable of adjusting the pressure Pa in the space SP that the lower surface 28B of the first member 28 faces. The control apparatus 4 uses the chamber apparatus CH or the second discharge apparatus 26, or both, to adjust the pressure Pa or the pressure Pb, or both, such that the first portion 281 of the first member 28 recovers the liquid LQ together with the gas G from the space SP and such that the second portion 282 recovers the liquid LQ while hindering the inflow of the gas G. In addition, the control apparatus 4 uses the first discharge apparatus 24 or the second discharge apparatus 26, or both, to set the pressure Pb or the pressure Pc, or both, such that the second members 27 discharge the liquid LQ from the recovery passageway 19 while hindering the inflow of the gas G. Furthermore, the second discharge apparatus 26 does not have to be capable of adjusting the pressure Pb.

Furthermore, the exposure apparatus EX comprises the first discharge apparatus 24 or the second discharge apparatus 26, or both. Furthermore, the first discharge apparatus 24 or the second discharge apparatus 26, or both, may be an apparatus that is external to the exposure apparatus EX. Furthermore, the first discharge apparatus 24 or the second discharge apparatus 26, or both, may be equipment in the factory wherein the exposure apparatus EX is installed.

In the present embodiment, at least part of the surface of the liquid immersion member 3 includes a surface of an amorphous carbon film. The amorphous carbon film may be a tetrahedral amorphous carbon film. In the present embodiment, at least part of the surface of the liquid immersion member 3 includes a surface of a tetrahedral amorphous carbon film. In the present embodiment, at least part of the surface of the liquid immersion member 3 that contacts the liquid LQ in the immersion space LS during an exposure of the substrate P includes a surface of an amorphous carbon film (i.e., a tetrahedral amorphous carbon film). In the present embodiment, the base material of the plate part 31 and the main body part 32 may be titanium, and the amorphous carbon film is formed on the surface of that base material. In the present embodiment, the base material of the first member 28 and the second members 27 may be titanium, and the amorphous carbon film is formed on the surface of that base material.

Furthermore, the base material of the liquid immersion member 3, which comprises the plate part 31, the main body part 32, the first member 28, or the second members 27, or any combination thereof, may be a metal, such as stainless steel or aluminum, or a ceramic material.

Furthermore, the amorphous carbon film may be formed on the base material using, for example, chemical vapor deposition (CVD), physical vapor deposition (PVD), and the like.

Furthermore, at least part of the surface of the liquid immersion member 3 does not have to include the surface of the amorphous carbon film.

A method of using the exposure apparatus EX that has the configuration discussed above to expose the substrate P will now be explained. In order to form the immersion space LS between the last optical element 8 and the liquid immersion member 3 on one side and the substrate P on the other side after the unexposed substrate P has been loaded onto the substrate holding part 10, the control apparatus 4 causes the substrate P held by the substrate stage 2 to oppose the emergent surface 7 and the lower surface 14. In the state wherein the substrate P opposes the emergent surface 7 and the lower surface 14, the immersion space LS is formed by supplying the liquid LQ via the supply ports 17 such that the optical path K of the exposure light EL between the last optical element 8 and the substrate P is filled with the liquid LQ.

In the present embodiment, the immersion space LS is formed with the liquid LQ between the last optical element 8 and the liquid immersion member 3 on one side and the substrate P (i.e., the object) on the other side by recovering the liquid LQ via the recovery ports 18 in parallel with supplying the liquid LQ via the supply ports 17.

Furthermore, in the present embodiment, the dimension (i.e., the size) of the immersion space LS is prescribed such that the interface LG of the liquid LQ in the immersion space LS is disposed between the first portion 281 and the object in the state wherein the object (i.e., the substrate P) opposing the last optical element 8 and the liquid immersion member 3 is substantially stationary. The control apparatus 4 controls the amount of the liquid LQ supplied per unit of time via the supply ports 17 and the amount of the liquid LQ recovered per unit of time via the recovery ports 18 such that the interface LG is formed between the first portion 281 and the object in the state wherein the object is substantially stationary.

Furthermore, in the state wherein the object is substantially stationary, the interface LG of the liquid LQ in the immersion space LS may be disposed between the second portion 282 and the object.

The control apparatus 4 starts the process of exposing the substrate P. The control apparatus 4 radiates the exposure light EL, which emerges from the mask M illuminated with the exposure light EL from the illumination system IL, to the substrate P through the projection optical system PL and the liquid LQ in the immersion space LS. Thereby, the substrate P is exposed with the exposure light EL, which transits the liquid LQ in the immersion space LS and emerges from the emergent surface 7, and thus the image of the pattern of the mask M is projected to the substrate P.

When recovering the liquid LQ via the recovery ports 18, the control apparatus 4 operates the second discharge apparatus 26 to discharge the gas G from the recovery passageway 19 via the second discharge ports 22. Thereby, the pressure Pb in the recovery passageway 19 decreases. In the present embodiment, the control apparatus 4 controls the second discharge apparatus 26 such that the pressure Pb in the recovery passageway 19 is lower than the pressure Pa in the space SP. By the lowering of the pressure Pb to a pressure lower than the pressure Pa, at least some of the liquid LQ is recovered from the space above the substrate P to the recovery passageway 19 via the holes 28H of the first member 28. In addition, at least some of the gas G is recovered from the space SP to the recovery passageway 19 via the holes 28H. The liquid LQ and the gas G are separately discharged from the recovery passageway 19 via the discharge parts 20.

In the present embodiment, the discharge operation via the second discharge ports 22 is performed in the state wherein the hindering part 40, which comprises the projection 41 and the liquid repellent part 42, is disposed at least partly around the second discharge ports 22. The gas G is discharged from the recovery passageway 19 via the second discharge ports 22 while the hindering part 40 hinders the liquid LQ in the recovery passageway 19 from contacting the second discharge ports 22.

In the present embodiment, the liquid LQ and the gas G flow in the recovery passageway 19 such that the liquid LQ in the recovery passageway 19 contacts the first discharge ports 21 but not the second discharge ports 22. In the present embodiment, the arrangement of the first discharge ports 21, the second discharge ports 22, the recovery ports 18, and the like, and, for example, the shape of the inner surface of the recovery passageway 19, a characteristic (e.g., the contact angle) of the inner surface of the recovery passageway 19 with respect to the liquid LQ, the shape of the surface of each of the members that faces the recovery passageway 19, and a characteristic (e.g., the contact angle) of the surface of the members that face the recovery passageway 19 with respect to the liquid LQ are prescribed such that the liquid LQ recovered to the recovery passageway 19 via the holes 28H of the first member 28 flows toward the first discharge ports 21 without contacting the second discharge ports 22.

In the present embodiment, the liquid LQ is recovered to the recovery passageway 19 via the first portion 281 of the first member 28, together with the gas G, and is recovered to the recovery passageway 19 via the second portion 282 while hindering the flow of the gas G into the recovery passageway 19.

Because the pressure Pb in the recovery passageway 19 decreases to a pressure lower than the pressure Pa in the space SP between the liquid immersion member 3 and the substrate P, the liquid LQ in the space above the substrate P flows into the recovery passageway 19 via the recovery ports 18 (i.e., the first member 28). Namely, because a pressure differential is generated between the upper surface 28A and the lower surface 28B of the first member 28, the liquid LQ in the space above the substrate P flows into the recovery passageway 19 via the recovery ports 18 (i.e., the first member 28).

In addition, the control apparatus 4 operates the first discharge apparatus 24 in order to discharge the liquid LQ from the recovery passageway 19 via the first discharge ports 21. The operation of the first discharge apparatus 24 lowers the pressure in the passageways 30. In the present embodiment, the control apparatus 4 controls the first discharge apparatus 24 such that the pressure Pc in the passageways 30 becomes lower than the pressure Pb in the recovery passageway 19.

The control apparatus 4 controls the first discharge apparatus 24 and thereby controls the pressure Pc in the passageways 30 such that only the liquid LQ is discharged to the passageways 30 via the second members 27.

By making the pressure Pc in the passageways 30 lower than the pressure Pb in the recovery passageway 19, the liquid LQ in the recovery passageway 19 flows into the passageways 30 via the first discharge ports 21 (i.e., the second members 27). Namely, because a pressure differential is generated between the upper surface 27A and the lower surface 27B of each of the second members 27, the liquid LQ in the recovery passageway 19 flows into the passageways 30 via the first discharge ports 21 (i.e., the second members 27).

During the recovery of the liquid LQ via the recovery ports 18, the liquid LQ continues to be discharged from the recovery passageway 19 via the first discharge ports 21. To recover the liquid LQ via the recovery ports 18, the second discharge ports 22 continue to discharge the gas G from the recovery passageway 19.

To discharge only the gas G from the recovery passageway 19, the second discharge ports 22 hinder the pressure Pb in the recovery passageway 19 from fluctuating greatly. Namely, the pressure Pb in the recovery passageway 19 is held substantially constant by ensuring a continuous gas passageway between the second discharge apparatus 26 and the gas space at the upper part of the recovery passageway 19 and by the second discharge ports 22 continuing to discharge the gas G from the recovery passageway 19. Because the pressure Pb in the recovery passageway 19 is substantially constant, fluctuations in the amount of the liquid LQ recovered per unit of time from the space above the substrate P (i.e., in the immersion space LS) via the recovery ports 18 are hindered.

In the present embodiment, to form the immersion space LS, the supply ports 17 supply a prescribed amount of the liquid LQ per unit of time. In the present embodiment, the supply ports 17 continue to supply a substantially constant amount of the liquid LQ. In addition, the recovery ports 18 recover a prescribed amount of the liquid LQ per unit of time. In the present embodiment, the recovery ports 18 continue to recover a substantially constant amount of the liquid LQ. Accordingly, large fluctuations in the immersion space LS are hindered.

In the present embodiment, the liquid LQ recovered to the recovery passageway 19 via the recovery ports 18 flows toward the first discharge ports 21 (i.e., the second members 27) while contacting at least part of the inner surface of the recovery passageway 19. The liquid LQ in the recovery passageway 19 that contacts any of the first discharge ports 21 (i.e., the second members 27) is discharged via those first discharge ports 21. For example, the liquid LQ recovered via the holes 28H of the first portion 281 flows on the upper surface 28A of the first member 28 toward the first discharge ports 21 (i.e., the second members 27). The liquid LQ is discharged from the recovery passageway 19 via the first discharge ports 21 such that the flow of the gas G from the recovery passageway 19 into the second discharge ports 22 is maintained. The control apparatus 4 controls the first discharge apparatus 24 or the second discharge apparatus 26, or both, such that the discharge of the gas G via the second discharge ports 22 continues and such that the liquid LQ is discharged via the first discharge ports 21.

In the present embodiment, when the liquid LQ is being recovered from the space above the substrate P via the first member 28, at least the upper surface 28A of the second portion 282 is covered by the liquid LQ in the recovery passageway 19. In the present embodiment as shown in FIG. 2 and FIG. 5, in the recovery passageway 19, substantially the entire area of the upper surface 28A of the first member 28 is covered by the liquid LQ in the recovery passageway 19. Namely, in the recovery passageway 19, substantially all of the upper surface 28A contacts the liquid LQ. Thereby, the liquid selective recovery condition is satisfied for the majority of the holes 28H of the second portion 282, and substantially only the liquid LQ is recovered via the second portion 282.

In the present embodiment, the liquid LQ is recovered together with the gas G via the first portion 281 of the first member 28, and the flow of the liquid LQ in the vicinity of the interface LG of the immersion space LS is hindered from stagnating. Accordingly, the contamination of the first member 28 (e.g., the adherence of particles thereto) and the dropping of particles from the first member 28 can be hindered. Namely, in the present embodiment, the first portion 281 recovers the liquid LQ together with the gas 0, and consequently the adhesion of foreign matter to the first member 28 (i.e., the first portion 281) is hindered. For example, the liquid LQ recovered together with the gas G flows at a high velocity in the vicinity of the surface of the first portion 281. Thereby, the flow of that liquid LQ can hinder the adhesion of foreign matter to the first portion 281. In addition, even if foreign matter were to adhere to the surface of the first portion 281, the flow of that liquid LQ could eliminate the foreign matter from the surface of the first portion 281, and that eliminated foreign matter could be recovered to the recovery passageway 19 together with the liquid LQ. In addition, because the flow of the gas G from the space SP into the recovery passageway 19 via the second portion 282 is hindered, the flow of the gas G into the recovery passageway 19 via the holes 28H of the first portion 281 that face the gas space GS can be maintained stably. Thereby, the immersion space LS can be formed in the desired state while preventing exposure failures from occurring.

Furthermore, in the present embodiment as discussed above, at least part of the surface of the liquid immersion member 3, which includes the surface of the first member 28, includes a surface of an amorphous carbon film. Accordingly, the adhesion of foreign matter produced by the substrate P to the surface of the liquid immersion member 3 is hindered.

In addition, in the present embodiment, when the liquid LQ is being recovered via the recovery ports 18, the liquid LQ in the recovery passageway 19 continues to contact at least part of each of the second members 27. Namely, when the liquid LQ is being recovered via the recovery ports 18, at least part of each of the second members 27 continues to be disposed in the liquid space in the recovery passageway 19.

In the present embodiment, because each of the second members 27 comprises the third portion 271 and the fourth portion 272, the second members 27 can continue to contact the liquid LQ in the liquid space in the recovery passageway 19 even if, for example, the surface height (i.e., the water level or the liquid level) of the liquid space in the recovery passageway 19 varies. Accordingly, each of the second members 27 can continue to discharge the liquid LQ in the recovery passageway 19 continuously via the corresponding first discharge ports 21 in the third portion 271 or the corresponding first discharge ports 21 in the fourth portion 272, or both. Thereby, it is possible to hinder, for example, fluctuations in the pressure in the recovery passageway 19 and the generation of vibration.

In addition, in the recovery passageway 19, if the surface height (i.e., the water level or the liquid level) of the liquid space is a first height and the liquid LQ in the liquid space contacts the third portions 271 and not the fourth portions 272, then the liquid LQ is discharged via the third portions 271. Moreover, if the surface height of the liquid space in the recovery passageway 19 is a second height, which is higher than the first height, and the liquid LQ in the liquid space contacts both the third portions 271 and the fourth portions 272, then that liquid LQ is discharged via the third portions 271 and the fourth portions 272. Because the fourth portions 272 are capable of discharging a greater amount of the liquid LQ than the third portions 271 are, the amount of the liquid LQ discharged via the second members 27 increases if the height of the surface of the liquid space in the recovery passageway 19 increases. Moreover, if the height of the surface of the liquid space decreases, then the amount of the liquid LQ discharged via the second members 27 decreases. Accordingly, fluctuations in the height of the surface of the liquid space in the recovery passageway 19 can be hindered.

According to the present embodiment as explained above, because each of the second members 27 comprise the third portion 271 and the fourth portion 272, the liquid LQ can be recovered smoothly. Accordingly, the desired immersion space LS can be formed. Consequently, it is possible to prevent exposure failures from occurring and defective devices from being produced.

Furthermore, in the present embodiment, the second portion 282 recovers only the liquid LQ and not the gas G; however, the flow of the gas G into the recovery passageway 19 via the holes 28H of the second portion 282 that face the gas space GS does not have to be hindered completely. Namely, the gas G may flow into the recovery passageway 19 via the holes 28H of the second portion 282 that face the gas space GS.

Furthermore, when the liquid LQ is being recovered from the space above the substrate P (i.e., the object) via the first member 28, all, or just some, of the holes 28H of the second portion 282 may be covered with the liquid LQ inside the recovery passageway 19.

In addition, it is permissible for just some, and not all, of the holes 28H of the second portion 282 to satisfy the liquid selective recovery condition discussed above.

### Second Embodiment

A second embodiment will now be explained. In the explanation below, constituent parts that are identical or equivalent to those in the embodiment discussed above are assigned identical symbols, and the explanations thereof are therefore abbreviated or omitted.

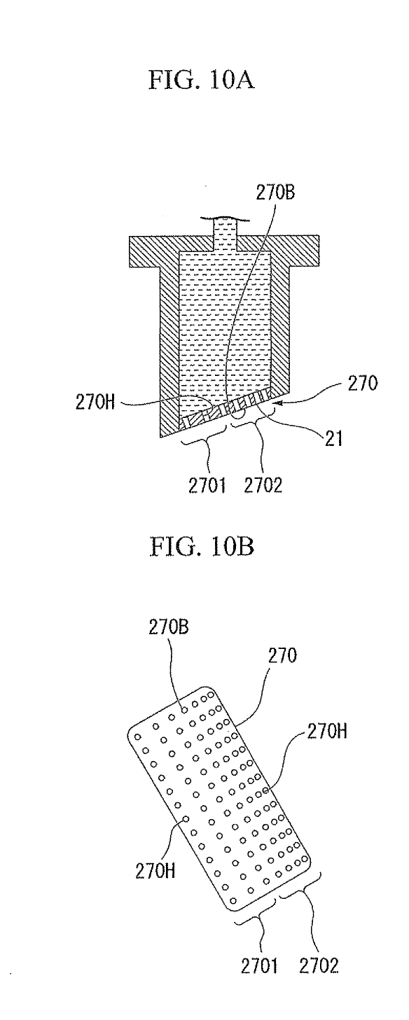

FIGS. 10A and 10B include views that show one example of a second member 270 according to the second embodiment. The second member 270 comprises a third portion 2701 and a fourth portion 2702, which is disposed at a position higher than the third portion 2701 is and is capable of discharging a greater amount of the liquid LQ than the third portion 2701 is. In the second member 270, the spacing between adjacent holes 270H in the third portion 2701 is larger than the spacing between adjacent holes 270H in the fourth portion 2702. The percentage of the first discharge ports 21 (i.e., the holes 270H) per unit of area in a lower surface 270E is larger in the fourth portion 2702 than in the third portion 2701. In addition, the number of the first discharge ports 21 (i.e., the holes 270H) in the fourth portion 2702 is larger than the number of the first discharge ports 21 (i.e., the holes 270H) in the third portion 2701.

### Third Embodiment

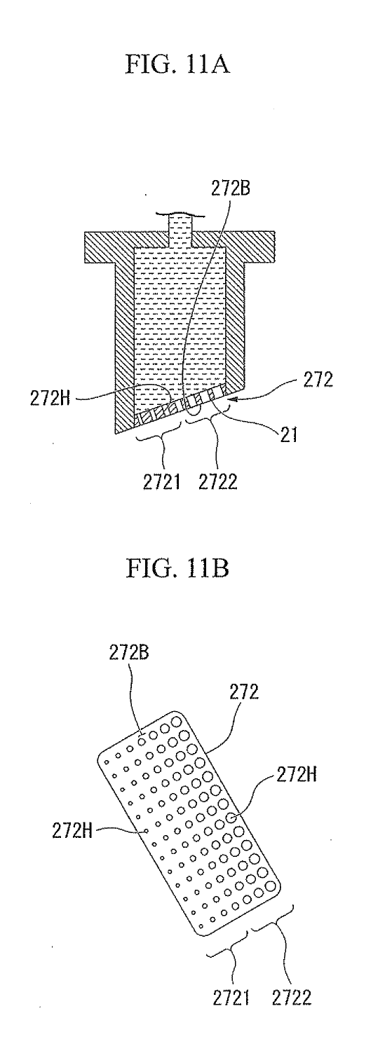

A third embodiment will now be explained. FIGS. 11A and 1113 include views that show one example of a second member 2720 according to the third embodiment. The second member 2720 comprises a third portion 2721 and a fourth portion 2722, which is disposed at a position higher than the third portion 2721 is and is capable of discharging a greater amount of the liquid LQ than the third portion 2721 is. In the second member 2720, the dimension of holes 272H in the fourth portion 2722 is larger than the dimension of the holes 272H in the third portion 2721. In the example shown in FIG. 11, the percentage of the first discharge ports 21 (i.e., the holes 272H) per unit of area in a lower surface 272B is larger in the fourth portion 2722 than in the third portion 2721.

### Fourth Embodiment

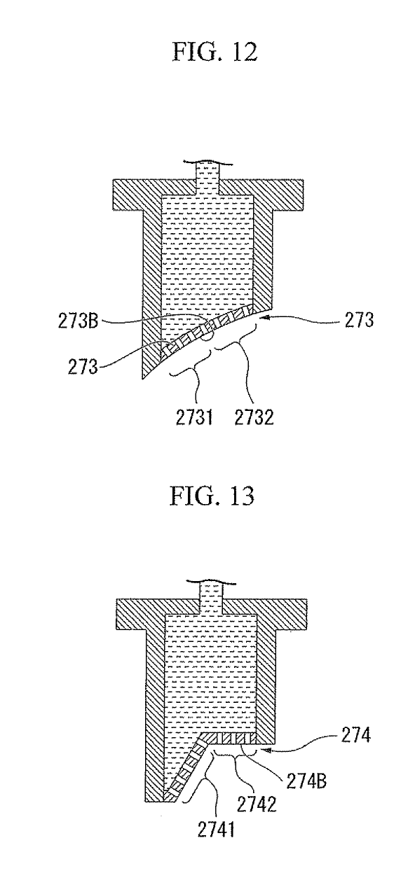

A fourth embodiment will now be explained. FIG. 12 is a view that shows one example of a second member 273 according to the fourth embodiment. The second member 273 comprises a third portion 2731 and a fourth portion 2732, which is disposed at a position higher than the third portion 2731 is and is capable of discharging a greater amount of the liquid LQ than the third portion 2731 is. In FIG. 12, at least part of a lower surface 273B is indented. In the example shown in FIG. 12, at least part of the lower surface 273B is a curved surface.

In the recovery passageway 19, if the surface height (i.e., the water level or the liquid level) of the liquid space is a first height and the liquid LQ in the liquid space contacts the third portion 2731 and not the fourth portion 2732, then the liquid LQ is discharged via the third portion 2731. Moreover, if the surface height of the liquid space is a second height, which is higher than the first height, and the liquid LQ in the liquid space contacts both the third portion 2731 and the fourth portion 2732, then that liquid LQ is discharged via the third portion 2731 and the fourth portion 2732. Because the lower surface 273B is an indented curved surface, if the height of the surface of the liquid space increases, then the contact area between the liquid LQ and the lower surface 273B increases and the amount of the liquid LQ discharged via the second member 273 increases. Moreover, if the height of the surface of the liquid space decreases, then the contact area between the liquid LQ and the lower surface 273B decreases and the amount of the liquid LQ discharged via the second member 273 decreases. Accordingly, in the second member 273 shown in FIG. 12, too, fluctuations in the height of the surface of the liquid space in the recovery passageway 19 can be hindered.

### Fifth Embodiment

A fifth embodiment will now be explained. FIG. 13 is a view that shows one example of a second member 274 according to the fifth embodiment. The second member 274 comprises a third portion 2741 and a fourth portion 2742, which is disposed at a position higher than the third portion 2741 is and is capable of discharging a greater amount of the liquid LQ than the third portion 2741 is. In FIG. 13, at least part of a lower surface 274B is indented. In the example shown in FIG. 13, the lower surface 274B includes an area that forms a first angle with the horizontal plane and an area that forms a second angle, which is different from the first angle, with the horizontal plane. In the present embodiment, the third portion 2741 has the area that forms the first angle, and the fourth portion 2742 has the area that forms the second angle. In the present embodiment, the angle of the lower surface 274B in the fourth portion 2742 with respect to the horizontal plane is larger than the angle of the lower surface 274B in the third portion 2741 with respect to the horizontal plane.

In the second member 274 shown in FIG. 13, too, if the surface height of the liquid space in the recovery passageway 19 increases, then the area of contact between the liquid LQ and the lower surface 274B increases. Moreover, if the surface height of the liquid space decreases, then the area of contact between the liquid LQ and the lower surface 274B decreases. Accordingly, in the second member 274 shown in FIG. 13, too, fluctuations in the height of the surface of the liquid space in the recovery passageway 19 can be hindered.

Furthermore, in the first through fifth embodiments discussed above, at least some of the first discharge ports 21 are disposed in an inclined surface such that they face the inner side in the radial directions with respect to the optical path K; however, some of the first discharge ports 21 may be provided to an inclined surface such that they face the outer side in the radial directions with respect to the optical path K, or at least part of at least one of the first discharge ports 21 may be provided to a plane that is parallel to the Z axis.

### Sixth Embodiment

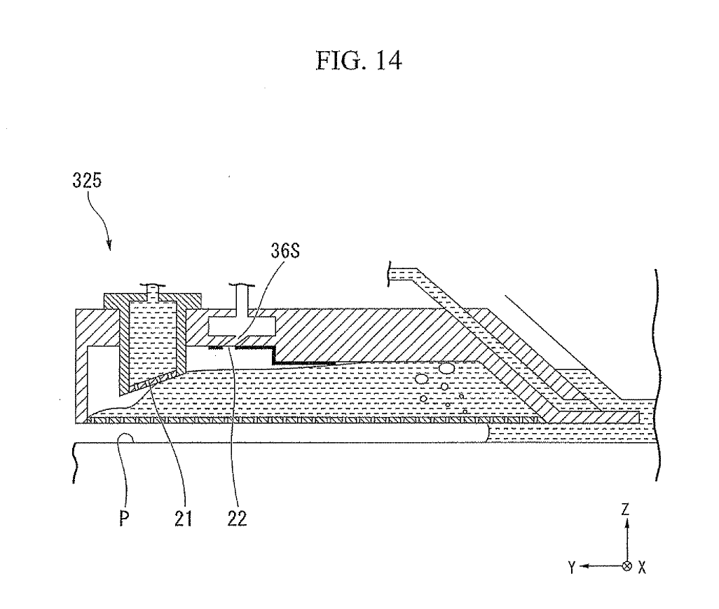

A sixth embodiment will now be explained. FIG. 14 is a partial side cross sectional view of a liquid immersion member 325 according to the sixth embodiment. In FIG. 14, the liquid immersion member 325 has passageways 36S, which are inclined and connected to the second discharge ports 22. The second discharge port 22 is disposed at the lower end of the passageway 36S. The passageway 36S extends upward from the second discharge port 22 toward the inner side in the radial directions with respect to the optical path K. Thereby, the liquid LQ is hindered from flowing into the passageway 36S via the second discharge port 22.

### Seventh Embodiment

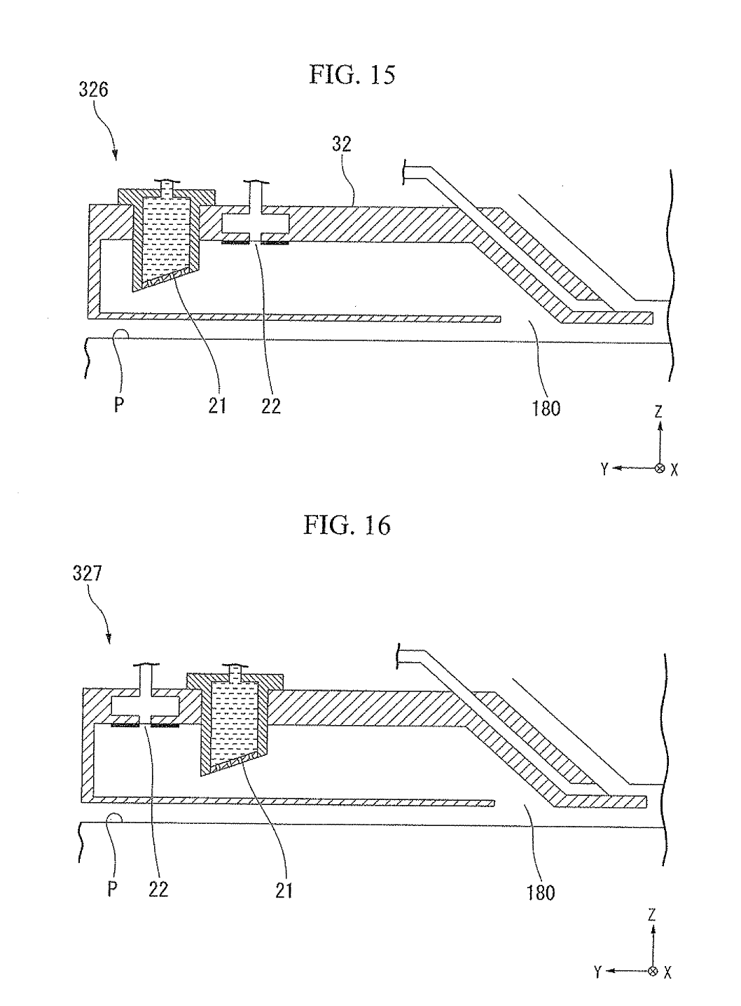

A seventh embodiment will now be explained. FIG. 15 is a partial side cross sectional view of a liquid immersion member 326 according to the seventh embodiment. In FIG. 15, the liquid immersion member 326 does not comprise the first member (i.e., the porous member). A recovery port 180 of the liquid immersion member 326 includes the opening formed at the lower end of the main body part 32.

The first discharge ports 21 and the second discharge port 22 of the liquid immersion member 326 are disposed on the outer side of the recovery port 180 in radial directions with respect to the optical path K. The first discharge ports 21 are disposed on the outer side of the second discharge port 22 in the radial directions with respect to the optical path K.

The first discharge ports 21 and the second discharge port 22 of a liquid immersion member 327 shown in FIG. 16 is disposed on the outer side of the recovery port 180 in radial directions with respect to the optical path K. The first discharge ports 21 are disposed on the inner side of the second discharge port 22 in the radial directions with respect to the optical path K.

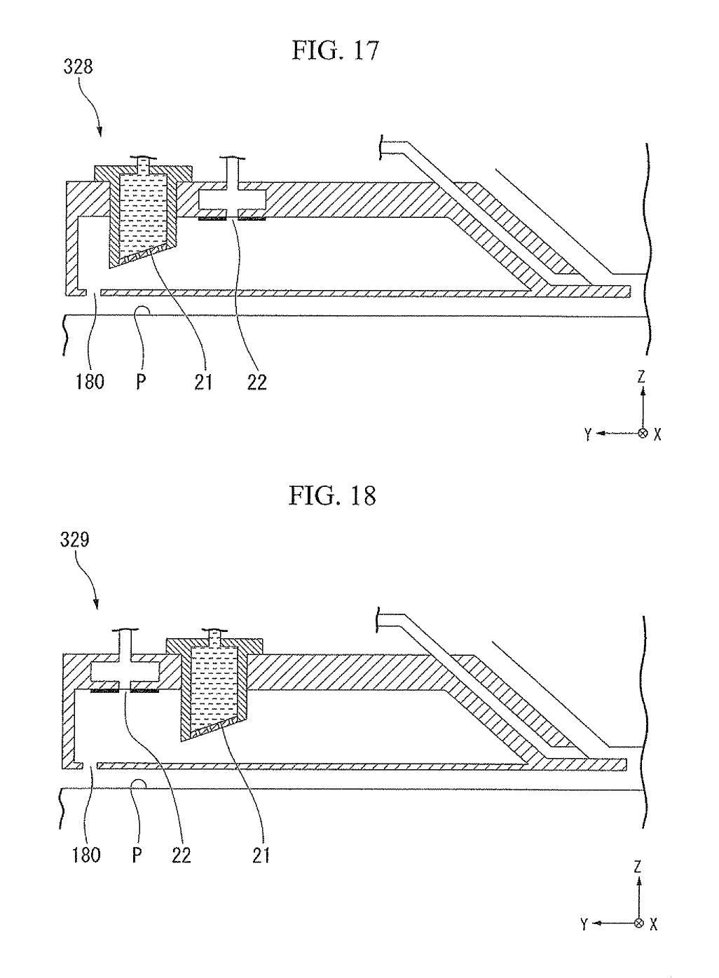

The first discharge ports 21 and the second discharge port 22 of a liquid immersion member 328 shown in FIG. 17 are disposed on the inner side of the recovery port 180 in the radial directions with respect to the optical path K. The first discharge ports 21 are disposed on the outer side of the second discharge port 22 in the radial directions with respect to the optical path K.

The first discharge ports 21 and the second discharge port 22 of a liquid immersion member 329 shown in FIG. 18 are disposed on the inner side of the recovery port 180 in the radial directions with respect to the optical path K. The first discharge ports 21 are disposed on the inner side of the second discharge port 22 in the radial directions with respect to the optical path K.

Furthermore, in each of the embodiments discussed above, the inflow of the gas into the recovery passageway 19 via first portion (i.e., 281 and the like) may be hindered. Namely, substantially only the liquid LQ may flow into the recovery passageway 19 also via the first portion (i.e., 281 and the like).

In a case both of the first portion (i.e., 281 and the like) and the second portion (i.e., 282 and the like) recover substantially only the liquid LQ, a suction of the gas via the second discharge ports 22 may be stopped or the second discharge ports 22 are not necessary to be provided.

Furthermore, in each of the embodiments discussed above, the “radial directions with respect to the optical path K” may be regarded as the radial directions with respect to the optical axis AX of the projection optical system PL in the vicinity of the projection area PR.

Furthermore, as discussed above, the control apparatus 4 comprises a computer system, which comprises a CPU and the like. In addition, the control apparatus 4 comprises an interface, which is capable of conducting communication between the computer system and the external apparatus. The storage apparatus 5 comprises a storage medium such as memory (e.g., RAM), a hard disk, a CD-ROM, and the like. In the storage apparatus 5, an operating system (OS) that controls a computer system is installed and a program for controlling the exposure apparatus EX is stored in the storage apparatus 5.

Furthermore, the control apparatus 4 may be connected to an input apparatus that is capable of inputting an input signal. The input apparatus comprises input equipment, such as a keyboard and a mouse, or a communication apparatus, which is capable of inputting data from the external apparatus. In addition, a display apparatus, such as a liquid crystal display, may be provided.

Various information, including the program stored in the storage apparatus 5, can be read by the control apparatus 4 (i.e., the computer system). In the storage apparatus 5, a program is stored that causes the control apparatus 4 to control the exposure apparatus EX such that the substrate P is exposed with the exposure light EL, which transits the liquid LQ.

The program stored in the storage apparatus 5 may cause the control apparatus 4 to execute the following processes according to the embodiments discussed above: a process that forms the immersion space such that the optical path of the exposure light radiated to the substrate is filled with the liquid; a process that exposes the substrate with the exposure light, which transits the liquid in the immersion space; a process that recovers at least some of the liquid from the space above the substrate via the recovery ports of the first member; a process that discharges at least some of the liquid from the recovery passageway via, of the portions of each of the second members that have the first discharge ports that are capable of discharging the liquid from the recovery passageway wherethrough the liquid recovered from the recovery ports flows, the first portion or the second portion, which is disposed at a position higher than the first portion and is capable of discharging a greater amount of the liquid than the first portion is, or both; and a process that discharges at least some of the gas from the recovery passageway via the second discharge ports, which are capable of discharging the gas from the recovery passageway.

The program stored in the storage apparatus 5 may cause the control apparatus 4 to execute the following processes according to the embodiments discussed above: a process that forms the immersion space such that the optical path of the exposure light radiated to the substrate is filled with the liquid; a process that exposes the substrate with the exposure light, which transits the liquid in the immersion space; a process that recovers at least some of the liquid from the space above the substrate via the recovery ports of the first member; a process that discharges at least some of the liquid from the recovery passageway, wherethrough the liquid recovered via the recovery ports flow, via the first discharge ports of the holes of each of the second members, which has a third surface that is nonparallel with respect to the horizontal plane, a forth surface, which faces a direction other than that faced by the first surface, and a plurality of holes, which connect the third surface and the forth surface; and a process that discharges at least some of the gas from the recovery passageway via the second discharge ports, which are disposed such that they face the recovery passageway.

The program stored in the storage apparatus 5 may cause the control apparatus 4 to execute the following processes according to the embodiments discussed above: a process that forms the immersion space such that the optical path of the exposure light radiated to the substrate is filled with the liquid; a process that exposes the substrate with the exposure light, which transits the liquid in the immersion space; a process that recovers at least some of the liquid from the space above the substrate via the recovery ports of the first member; a process that discharges at least some of the liquid from the recovery passageway, wherethrough the liquid recovered via the recovery ports flow, via the first discharge ports of the holes of each of the second members, which has a first surface, at least part of which includes a curved surface, a second surface, which faces a direction other than that faced by the first surface, and a plurality of holes, which connect the first surface and the second surface; and a process that discharges at least some of the gas from the recovery passageway via the second discharge ports, which are disposed such that they face the recovery passageway.

The program stored in the storage apparatus 5 is read by the control apparatus 4, and thereby the various processes, such as the immersion exposure of the substrate P in the state wherein the immersion space LS is formed, are executed in cooperation with the various apparatuses of the exposure apparatus EX, such as the substrate stage 2, the liquid immersion member 3, the liquid supply apparatus 35, the first discharge apparatus 24, and the second discharge apparatus 26.

Furthermore, in the embodiments discussed above, the optical path K on the emergent (i.e., the image plane) side of the last optical element 8 of the projection optical system PL is filled with the liquid LQ; however, the projection optical system PL may be a projection optical system wherein the optical path K on the incident (i.e., the object plane) side of the last optical element 8 is also filled with the liquid LQ, as disclosed in, for example, PCT International Publication No. WO2004/019128.

Furthermore, in each of the embodiments discussed above, the liquid LQ is water but may be a liquid other than water. Preferably, the liquid LQ is a liquid that is transparent with respect to the exposure light EL, has a high refractive index with respect to the exposure light EL, and is stable with respect to the projection optical system PL or the film of, for example, the photosensitive material (i.e., the photoresist) that forms the front surface of the substrate P. For example, the liquid LQ may be a fluorine-based liquid such as hydro-fluoro-ether (HFE), perfluorinated polyether (PFPE), or Fomblin® oil. In addition, the liquid LQ may be any of various fluids, for example, a supercritical fluid.

Furthermore, the substrate P in each of the embodiments discussed above is a semiconductor wafer for fabricating semiconductor devices, but may be, for example, a glass substrate for display devices, a ceramic wafer for thin film magnetic heads, or the original plate of a mask or a reticle (e.g., synthetic quartz or a silicon wafer) used by an exposure apparatus.

Furthermore, the exposure apparatus EX in each of the embodiments discussed above is a step-and-scan type scanning exposure apparatus (i.e., a scanning stepper), which scans and exposes the pattern of the mask M by synchronously moving the mask M and the substrate P, but the exposure apparatus EX may be, for example, a step-and-repeat type projection exposure apparatus (i.e., a stepper), which performs a full field exposure of the pattern of the mask M—with the mask M and the substrate P in a stationary state—and then sequentially steps the substrate P.

In addition, the exposure apparatus EX may be a full-field exposure apparatus (i.e., a stitching type full-field exposure apparatus), which performs a full-field exposure of the substrate P; in this case, a step-and-repeat type exposure is performed using the projection optical system PL to transfer a reduced image of a first pattern onto the substrate P in a state wherein the first pattern and the substrate P are substantially stationary, after which the projection optical system PL is used to partially superpose a reduced image of a second pattern onto the transferred first pattern in the state wherein the second pattern and the substrate P are substantially stationary. In addition, the stitching type exposure apparatus may be a step-and-stitch type exposure apparatus that successively steps the substrate P and transfers at least two patterns onto the substrate P such that they are partially superposed.

In addition, the exposure apparatus EX may be an exposure apparatus that combines on the substrate P the patterns of two masks through a projection optical system and double exposes, substantially simultaneously, a single shot region on the substrate P using a single scanning exposure, as disclosed in, for example, U.S. Pat. No. 6,611,316. In addition, the exposure apparatus EX may be a proximity type exposure apparatus, a mirror projection aligner, or the like.

In addition, the exposure apparatus EX may be a twin stage type exposure apparatus, which comprises a plurality of substrate stages, as disclosed in, for example, U.S. Pat. Nos. 6,341,007, 6,208,407, and 6,262,796. For example, if the exposure apparatus EX comprises two of the substrate stages, then the object that is capable of being disposed such that it opposes the emergent surface 7 is one of the substrate stages, a substrate held by a substrate holding part on that substrate stage, the other of the substrate stages, the substrate held by a substrate holding part on that other substrate stage, or any combination thereof.

In addition, the exposure apparatus EX can also be adapted to an exposure apparatus that is provided with a substrate stage that holds a substrate and a measurement stage that does not hold the substrate to be exposed and whereon a fiducial member (wherein a fiducial mark is formed) and/or various photoelectric sensors are mounted, as disclosed in, for example, U.S. Pat. No. 6,897,963 and U.S. Patent Application Publication No. 2007/0127006. In such a case, the objects that are capable of being disposed such that they oppose the emergent surface 7 are the substrate stage, the substrate held by the substrate holding part on that substrate stage, the measurement stage, or any combination thereof. In addition, the exposure apparatus EX may be an exposure apparatus that comprises a plurality of the substrate stages and the measurement stages.

The exposure apparatus EX may be a semiconductor device fabrication exposure apparatus that exposes the pattern of a semiconductor device on the substrate P, an exposure apparatus used for fabricating, for example, liquid crystal devices or displays, or an exposure apparatus for fabricating thin film magnetic heads, image capturing devices (e.g., CCDs), micromachines, MEMS, DNA chips, or reticles and masks.

Furthermore, in each of the embodiments discussed above, the position of each of the stages is measured using an interferometer system 13, but the present invention is not limited thereto; for example, an encoder system that detects a scale (i.e., a diffraction grating) provided to each of the stages may be used, or the interferometer system 13 may be used in parallel with the encoder system.

Furthermore, in the embodiments discussed above, the optically transmissive mask M wherein a prescribed shielding pattern (or phase pattern or dimming pattern) is formed on an optically transmissive substrate is used; however, instead of such a mask, a variable shaped mask (also called an electronic mask, an active mask, or an image generator), wherein a transmissive pattern, a reflective pattern, or a light emitting pattern is formed based on electronic data of the pattern to be exposed, as disclosed in, for example, U.S. Pat. No. 6,778,257, may be used. In addition, instead of a variable shaped mask that comprises a non-emissive type image display device, a pattern forming apparatus that comprises a self-luminous type image display device may be provided.

In each of the embodiments discussed above, the exposure apparatus EX comprises the projection optical system PL; however, the constituent elements explained in each of the embodiments discussed above may be adapted to an exposure apparatus and an exposing method that does not use the projection optical system PL. For example, the constituent elements explained in each of the embodiments discussed above may be adapted to an exposure apparatus and an exposing method wherein the immersion space LS is formed between the substrate P and an optical member such as a lens, and the exposure light EL is radiated to the substrate P via that optical member.

In addition, the exposure apparatus EX may be an exposure apparatus (i.e., a lithographic system) that exposes the substrate P with a line-and-space pattern by forming interference fringes on the substrate P, as disclosed in, for example, PCT International Publication No. WO2001/035168.

The exposure apparatus EX according to the embodiments discussed above is manufactured by assembling various subsystems, including each constituent element discussed above, so that prescribed mechanical, electrical, and optical accuracies are maintained. To ensure these various accuracies, adjustments are performed before and after this assembly, including an adjustment to achieve optical accuracy for the various optical systems, an adjustment to achieve mechanical accuracy for the various mechanical systems, and an adjustment to achieve electrical accuracy for the various electrical systems. The process of assembling the exposure apparatus EX from the various subsystems includes, for example, the connection of mechanical components, the wiring and connection of electrical circuits, and the piping and connection of the pneumatic circuits among the various subsystems. Prior to performing the process of assembling the exposure apparatus EX from these various subsystems, there are also the processes of assembling each individual subsystem. After the process of assembling the exposure apparatus EX from the various subsystems is complete, a comprehensive adjustment is performed to ensure the various accuracies of the exposure apparatus EX as a whole. Furthermore, it is preferable to manufacture the exposure apparatus EX in a clean room, wherein the temperature, the cleanliness level, and the like are controlled.

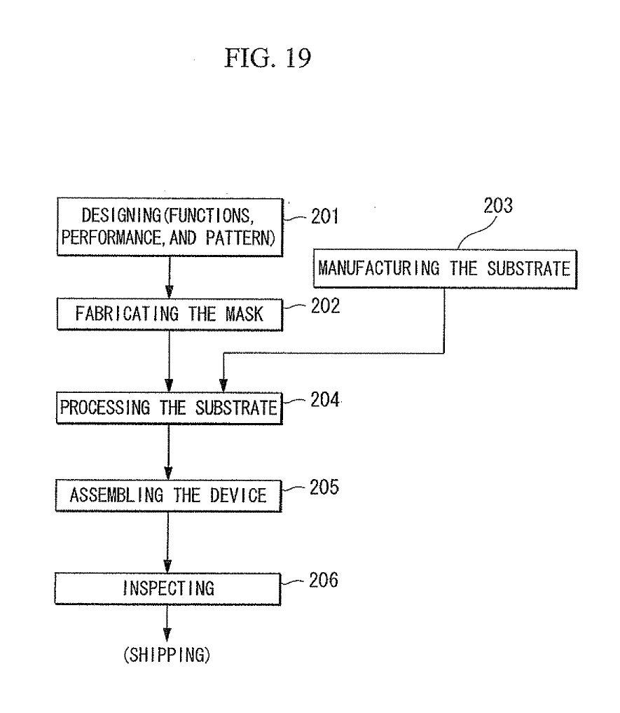

As shown in FIG. 19, a microdevice, such as a semiconductor device, is manufactured by: a step 201 that designs the functions and performance of the microdevice; a step 202 that fabricates the mask M (i.e., the reticle) based on this designing step; a step 203 that manufactures the substrate P, which is the base material of the device; a substrate processing step 204 that comprises a substrate process (i.e., an exposure process) that includes, in accordance with the embodiments discussed above, exposing the substrate P with the exposure light EL that emerges from the pattern of the mask M and developing the exposed substrate P; a device assembling step 205 (which includes fabrication processes such as dicing, bonding, and packaging processes); an inspecting step 206; and the like.

Furthermore, the features of each of the embodiments discussed above can be combined as appropriate. In addition, there are also cases wherein some of the constituent elements are not used. In addition, each disclosure of every Japanese published patent application and U.S. patent related to the exposure apparatus EX recited in each of the embodiments discussed above, the modified examples, and the like is hereby incorporated by reference in its entirety to the extent permitted by the national laws and regulations.

1. A liquid immersion member, which is disposed inside an immersion exposure apparatus and at least partly around an optical member and around an optical path of exposure light that passes through a liquid between the optical member and an object, comprising:
a first member, which has a recovery port that recovers at least some of the liquid from a space above the object;
a recovery passageway, wherein the liquid recovered via the recovery port flows;
a second member, which faces the recovery passageway and has a first discharge port that is for discharging the liquid from the recovery passageway; and
a third member, which faces the recovery passageway and has a second discharge port that is for discharging a gas from the recovery passageway;
wherein,
the second member comprises a first portion and a second portion, which is disposed at a position higher than the first portion is and is capable of discharging a greater amount of the liquid than the first portion is.

2. The liquid immersion member according to claim 1, wherein
the second member has a first surface that faces the recovery passageway, a second surface that faces a direction other than that faced by the first surface, and a plurality of holes that connects the first surface and the second surface; and
the first discharge port includes at least one of the holes.

3. The liquid immersion member according to claim 1, wherein
the second portion is disposed such that it is more spaced apart from the first member than the first portion is.

4. The liquid immersion member according to claim 2, wherein
the liquid recovery capacity per unit of area of the third surface is higher in the second portion than in the first portion.

5. The liquid immersion member according to claim 2, wherein
the percentage of the area of the first surface that the hole occupies is larger in the second portion than in the first portion.

6. The liquid immersion member according to claim 2, wherein
the angle of the first surface with respect to the horizontal plane is smaller in the second portion than in the first portion.

7. The liquid immersion member according to claim 2, wherein
at least part of the first surface is nonparallel to the horizontal plane.

8. The liquid immersion member according to claim 7, wherein
the first surface includes an area that forms a first angle with the horizontal plane and an area that forms a second angle, which is different from the first angle, with the horizontal plane.

9. The liquid immersion member according to claim 2, wherein
at least part of the first surface is a curved surface.

10. The liquid immersion member according to tiny one claim 2, wherein
at least part of the first surface is indented.

11. The liquid immersion member according to claim 1, wherein
the first discharge port includes a plurality of holes and the dimension of the hole in the second portion is larger than the dimension of the hole in the first portion.

12. The liquid immersion member according to claim 1, wherein
the first discharge port includes a plurality of holes and the number of the holes in the second portion is larger than the number of the holes the first portion.

13. A liquid immersion member, which is disposed inside an immersion exposure apparatus and at least partly around an optical member and around an optical path of exposure light that passes through a liquid between the optical member and an object, comprising:
a first member, which has a recovery port that recovers at least some of the liquid from a space above the object;
a recovery passageway, wherein the liquid recovered via the recovery port flows;
a second member, which has a first surface that faces the recovery passageway, a second surface that faces a direction other than that faced by the first surface, and a plurality of holes that connects the first surface and the second surface, that discharges at least some of the liquid from the recovery passageway via a first discharge port of the holes; and
a third member, which faces the recovery passageway and has a second discharge port that is for discharging a gas from the recovery passageway;
wherein,
at least part of the first surface is nonparallel with respect to the horizontal plane.

14. The liquid immersion member according to claim 13, wherein
the first surface includes an area that forms a first angle with the horizontal plane and an area that forms a second angle, which is different from the first angle, with the horizontal plane.

15. A liquid immersion member, which is disposed inside an immersion exposure apparatus and at least partly around an optical member and around an optical path of exposure light that passes through a liquid between the optical member and an object, comprising:
a first member, which has a recovery port that recovers at least some of the liquid from a space above the object;
a recovery passageway, wherein the liquid recovered via the recovery port flows;
a second member, which has a first surface that faces the recovery passageway,
a second surface that faces a direction other than that faced by the first surface, and a plurality of holes that connects the first surface and the second surface, that discharges at least some of the liquid from the recovery passageway via a first discharge port of the holes; and
a third member, which faces the recovery passageway and has a second discharge port that is for discharging a gas from the recovery passageway;
wherein,
at least part of the first surface is a curved surface.

16. The liquid immersion member according to claim 13, wherein
at least part of the first surface is indented.

17. The liquid immersion member according to claim 1, wherein
the second member comprises a porous member.

18. The liquid immersion member according to claim 1, wherein
the liquid in the recovery passageway continues to contact at least part of the second member.

19. The liquid immersion member according to claim 1, wherein
a gas space and a liquid space are formed in the recovery passageway; and
the second discharge port is disposed in the gas space.

20. The liquid immersion member according to claim 19, wherein
at least part of the second member continues to be disposed in the liquid space.

21. The liquid immersion member according to claim 1, wherein
the first discharge port is disposed on the outer side of the second discharge port in the radial directions with respect to the optical path.

22. The liquid immersion member according to claim 1, wherein
the first member comprises a porous member; and
the liquid is recovered via the holes of the first member.

23. The liquid immersion member according to claim 1, wherein
the first discharge port discharges substantially only the liquid from the recovery passageway.

24. The liquid immersion member according to claim 23, wherein
at least part of the surface of the second member is lyophilic with respect to the liquid.

25. The liquid immersion member according to claim 1, wherein
the second discharge port discharges substantially only the gas from the recovery passageway.

26. The liquid immersion member according to claim 1, wherein
at least part of the first discharge port opposes the recovery port.

27. The liquid immersion member according to claim 1, wherein
at least part of the second discharge port opposes the recovery port.

28. The liquid immersion member according to claim 1, wherein
the first discharge port is disposed below the second discharge port.

29. An immersion exposure apparatus, which exposes a substrate with exposure light that transits a liquid, comprising:
the liquid immersion member according to claim 1.

30. A device fabricating method, comprising:
exposing a substrate using the immersion exposure apparatus according to claim 20; and
developing the exposed substrate.

31. A liquid recovering method that is used by an immersion exposure apparatus wherein an immersion space is formed such that an optical path of exposure light between an optical member, wherefrom the exposure light can emerge, and a substrate is filled with a liquid and the substrate is exposed with the exposure light that transits the liquid, comprising:
recovering at least some of the liquid from the space above the substrate via a recovery port of a first member;
discharging at least some of the liquid from a recovery passageway via at least one portion of a second member, which has a first discharge port that is capable of discharging the liquid from the recovery passageway wherethrough the liquid recovered via the recovery port flows, selected from the group consisting of a first portion and a second portion, which is disposed at a position higher than the first portion is and is capable of discharging a greater amount of the liquid than the first portion is; and
discharging at least some of a gas from the recovery passageway via a second discharge port of a third member that is capable of discharging the gas from the recovery passageway.

32. A liquid recovering method that is used by an immersion exposure apparatus wherein an immersion space is formed such that an optical path of exposure light between an optical member, wherefrom the exposure light can emerge, and a substrate is filled with a liquid and the substrate is exposed with the exposure light that transits the liquid, comprising:
recovering at least some of the liquid from the space above the substrate via a recovery port of a first member;
discharging at least some of the liquid from a recovery passageway, wherethrough the liquid recovered via the recovery port flows, via a first discharge port of a plurality of holes of a second member, which has a first surface that is nonparallel with respect to the horizontal plane, a second surface that faces a direction other than that faced by the first surface, and the plurality of the holes that connects the first surface and the second surface; and
discharging at least some of a gas from the recovery passageway via a second discharge port of a third member, which is disposed such that it faces the recovery passageway.

33. A liquid recovering method that is used by an immersion exposure apparatus wherein an immersion space is formed such that an optical path of exposure light between an optical member, wherefrom the exposure light can emerge, and a substrate is filled with a liquid and the substrate is exposed with the exposure light that transits the liquid, comprising:
recovering at least some of the liquid from the space above the substrate via a recovery port of a first member;
discharging at least some of the liquid from a recovery passageway, wherethrough the liquid recovered via the recovery port flows, via a first discharge port of a plurality of holes of a second member, which has a first surface, at least part of which is a curved surface, a second surface that faces a direction other than that faced by the first surface, and the plurality of the holes that connects the first surface and the second surface; and
discharging at least some of a gas from the recovery passageway via a second discharge port of a third member, which is disposed such that it faces the recovery passageway.

34. A device fabricating method, comprising:
filling an optical path of exposure light radiated to a substrate with a liquid using the liquid recovering method according to claim 31,
exposing the substrate with the exposure light that transits the liquid; and
developing the exposed substrate.

35. A program that causes a computer to control an exposure apparatus that exposes a substrate with exposure light that transits a liquid, comprising:
forming an immersion space such that an optical path of the exposure light radiated to the substrate is filled with the liquid;
exposing the substrate with the exposure light that transits the liquid in the immersion space;
recovering at least some of the liquid from a space above the substrate via a recovery port of a first member;
discharging at least some of the liquid from a recovery passageway via at least one portion of a second member, which has a first discharge port that is capable of discharging the liquid from the recovery passageway wherethrough the liquid recovered via the recovery port flows, from the group consisting of a first portion and a second portion, which is disposed at a position higher than the first portion is and is capable of discharging a greater amount of the liquid than the first portion is; and
discharging at least some of a gas from the recovery passageway via a second discharge port of a third member, which is capable of discharging the gas from the recovery passageway.

36. A program that causes a computer to control an exposure apparatus that exposes a substrate with exposure light that transits a liquid, comprising:
forming an immersion space such that an optical path of the exposure light radiated to the substrate is filled with the liquid;
exposing the substrate with the exposure light that transits the liquid in the immersion space;
recovering at least some of the liquid from a space above the substrate via a recovery port of a first member;
discharging at least some of the liquid from a recovery passageway, wherethrough the liquid recovered via the recovery port flows, via a first discharge port of a plurality of holes of a second member, which has a first surface that is nonparallel with respect to the horizontal plane, a second surface that faces a direction other than that faced by the first surface, and the plurality of the holes that connects the first surface and the second surface; and
discharging at least some of a gas from the recovery passageway via a second discharge port of a third member, which is disposed such that it faces the recovery passageway.

37. A program that causes a computer to control an exposure apparatus that exposes a substrate with exposure light that transits a liquid, comprising:
forming an immersion space such that an optical path of the exposure light radiated to the substrate is filled with the liquid;
exposing the substrate with the exposure light that transits the liquid in the immersion space;
recovering at least some of the liquid from a space above the substrate via a recovery port of a first member;
discharging at least some of the liquid from a recovery passageway, wherethrough the liquid recovered via the recovery port flows, via a first discharge port of a plurality of holes of a second member, which has a first surface, at least part of which is a curved surface, a second surface that faces a direction other than that faced by the first surface, and the plurality of the holes that connects the first surface and the second surface; and
discharging at least some of a gas from the recovery passageway via a second discharge port of a third member, which is disposed such that it faces the recovery passageway.

38. A computer readable storage medium, whereon the program according to claim 35 is stored.
